(19) United States
(12) Patent Application Publication
(10) Pub. No.: US 2025/0211875 A1
(43) Pub. Date: Jun. 26, 2025

(54) SOLID-STATE IMAGING DEVICE WITH DIFFERENCING CIRCUIT FOR FRAME DIFFERENCING

(71) Applicant: Sony Semiconductor Solutions Corporation, Kanagawa (JP)

(72) Inventors: Christian Peter BRÄNDLI, Aargau (CH); Massimo ZANNONI, Zurich (CH); Raphael BERNER, Zurich (CH); Eshar BEN DOR, Zurich (CH)

(73) Assignee: Sony Semiconductor Solutions Corporation, Kanagawa (JP)

(21) Appl. No.: 18/849,542

(22) PCT Filed: Mar. 7, 2023
(86) PCT No.: PCT/EP2023/055780

§ 371 Date: Sep. 23, 2024

(30) Foreign Application Priority Data
Mar. 31, 2022 (EP) 22166117.6

(51) Int. Cl. H04N 25/77; H04N 25/47; H04N 25/65; H04N 25/78

(52) U.S. Cl. CPC H04N 25/77; H04N 25/47; H04N 25/65; H04N 25/78

(57) ABSTRACT

A solid-state imaging device includes pixel circuits, wherein each pixel circuit outputs pixel signals on a data signal line in response to an active row select signal in a row selection interval. Each pixel circuit includes a floating diffusion, wherein a floating diffusion potential of the floating diffusion determines a voltage level of the pixel signals. For each of the pixel circuits, a differencing circuit receives two pixel signals successively transmitted from the pixel circuit on the data signal line within a same row selection interval. The differencing circuit obtains a difference signal from the two pixel signals. The solid-state imaging device controls each pixel circuit to output a previous pixel signal and a new pixel signal in a same row selection interval, wherein the previous pixel signal and the new pixel signal contain image information about an imaged scene at different points in time.

### FIELD OF THE INVENTION

The present disclosure relates to a solid-state imaging device including a differencing circuit for frame differencing. More particularly, the present disclosure relates to a solid-state imaging device including a differencing circuit for frame differencing on the basis of analog pixel signals.

### BACKGROUND

Image sensors in solid-state imaging devices include photoelectric conversion elements generating a photocurrent in proportion to the received radiation intensity. A pixel circuit transforms the small photocurrent generated by the photoelectric conversion element into a voltage signal. A source follower circuit outputs a corresponding pixel signal on a data line in a row selection interval. For intensity readout, a downstream ADC (analog-to-digital converter) converts the pixel signal into a digital pixel value.

Various frame differencing methods compare successive pixel signals obtained from the same pixel circuit to generate information indicative of changes in the imaged scene. Frame differencing facilitates fast methods for detecting motion in an imaged scene and for estimating motion vectors that describe speed and direction of moving objects in the imaged scene. Frame differencing may use the digital pixel values, wherein the digital values may be obtained by double sampling methods for reducing noise.

### SUMMARY

Solid-state imaging devices that use frame differencing with analog pixel signals suffer from noise that degrades image quality, particularly in low-light conditions. The present disclosure mitigates such shortcomings of the prior art discussed for frame differencing. In particular, the effect of noise on image quality can be reduced by providing a configuration of a differencing circuit that allows implementation of various noise reduction techniques with little additional effort.

To this purpose, a solid-state imaging device according to the present disclosure includes pixel circuits, wherein each pixel circuit outputs pixel signals on a data signal line in response to an active row select signal in a row selection interval. Each pixel circuit includes a floating diffusion, wherein a floating diffusion potential of the floating diffusion determines a voltage level of the pixel signals. For each of the pixel circuits, a differencing circuit receives two pixel signals successively transmitted from the pixel circuit on the data signal line within a same row selection interval. The differencing circuit obtains a difference signal from the two pixel signals. The solid-state imaging device controls each pixel circuit to output a previous pixel signal and a new pixel signal in the same row selection interval, wherein the previous pixel signal and the new pixel signal contain image information about an imaged scene at different points in time.

In particular, components of the differencing circuit can also be used for noise-reducing double sampling circuits and/or can be combined with kTC noise reduction circuits.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a simplified block diagram showing a solid-state imaging device with differencing circuits and double sampling circuits for noise reduction according to an embodiment of the present technology.

FIG. 2 is a simplified block diagram showing a solid-state imaging device with differencing circuits and kTC noise reduction circuits according to an embodiment of the present technology.

FIG. 3 is a simplified block diagram of a portion of an image sensor assembly with differencing circuits and a threshold drift compensation circuit according to another embodiment of the present technology.

FIG. 4 is a simplified block diagram of a portion of an image sensor assembly with differencing circuits and a double sampling circuit according to another embodiment of the present technology.

FIG. 5 is a simplified block diagram of a portion of an image sensor assembly with a differencing circuit including a sample capacitor, a gain capacitor and an amplifier circuit according to another embodiment of the present technology.

FIG. 6A is a simplified block diagram of a portion of an image sensor assembly with a differencing circuit including a sample capacitor, a gain capacitor and an amplifier circuit, and a kTC noise reduction circuit and a 5T pixel circuit according to another embodiment of the present technology.

FIG. 6B is a simplified time diagram of various internal signals and output signals of the image sensor assembly of FIG. 6A.

FIG. 7A is a simplified block diagram of a portion of an image sensor assembly with a differencing circuit including a sample capacitor, a gain capacitor and an amplifier circuit, and a 4T pixel circuit according to another embodiment of the present technology.

FIG. 7B is a simplified time diagram of various internal signals and output signals of the image sensor assembly of FIG. 7A.

FIG. 8A is a simplified block diagram of a portion of an image sensor assembly with a differencing circuit including a fully differential amplifier according to another embodiment of the present technology.

FIG. 8B is a simplified time diagram of various internal signals and output signals of the image sensor assembly of FIG. 8A.

FIG. 9A is a simplified block diagram of a portion of an image sensor assembly with a differencing circuit and noise reduction by CDS for new pixel signals according to another embodiment of the present technology.

FIG. 9B is a simplified time diagram of various internal signals and output signals of the image sensor assembly of FIG. 9A.

FIG. 10 is a simplified block diagram of a portion of an image sensor assembly combining a differencing circuit for noise reduction by CDS for new pixel signals with kTC noise reduction according to another embodiment of the present technology.

FIG. 11 is a simplified time diagram of various internal signals and output signals of the image sensor assembly of FIG. 10.

FIG. 12 is a simplified block diagram of a converter circuit including comparator portions according to an embodiment of the present technology.

FIG. 13 is a simplified block diagram of a converter circuit including an AD converter with adjustable threshold levels according to an embodiment of the present technology.

FIG. 14 is a simplified flow chart of a method of operating the converter circuit according to FIG. 13.

FIG. 15A is a simplified block diagram of a portion of an image sensor assembly with a differencing circuit outputting a binary difference signals according to an embodiment of the present technology.

FIG. 15B is a simplified time diagram of various internal signals and output signals of the image sensor assembly of FIG. 15A.

FIG. 16A is a simplified block diagram of a portion of an image sensor assembly with a differencing circuit integrated in an AD converter according to an embodiment of the present technology.

FIG. 16B is a simplified time diagram of various internal signals and output signals of the image sensor assembly of FIG. 16A.

FIG. 17 is a diagram showing an example of a laminated structure of a solid-state imaging device according to an embodiment of the present disclosure.

FIG. 18 is a block diagram depicting an example of a schematic configuration of a vehicle control system.

FIG. 19 is a diagram of assistance in explaining an example of installation positions of an outside-vehicle information detecting section and an imaging section of the vehicle control system of FIG. 18.

### DETAILED DESCRIPTION

Embodiments for implementing techniques of the present disclosure (also referred to as “embodiments” in the following) will be described below in detail using the drawings. The techniques of the present disclosure are not limited to the described embodiments, and various numerical values and the like in the embodiments are illustrative only. The same elements or elements with the same functions are denoted by the same reference signs. Duplicate descriptions are omitted.

Connected electronic elements may be electrically connected through a direct, permanent low-resistive connection, e.g., through a conductive line. The terms “electrically connected” and “signal-connected” may also include a connection through other electronic elements provided and suitable for permanent and/or temporary signal transmission and/or transmission of energy. For example, electronic elements may be electrically connected or signal-connected through resistors, capacitors, and electronic switches such as transistors or transistor circuits, e.g. FETs (field effect transistors), transmission gates, and others. The load path of a transistor is the controlled path of a transistor. For example, a voltage applied to a gate of a FET controls by field effect the current flow in the load path between source and drain.

Though in the following a technology for reducing temporal noise is described in the context of certain types of image sensors for intensity readout, the technology may also be used for other types of image sensors.

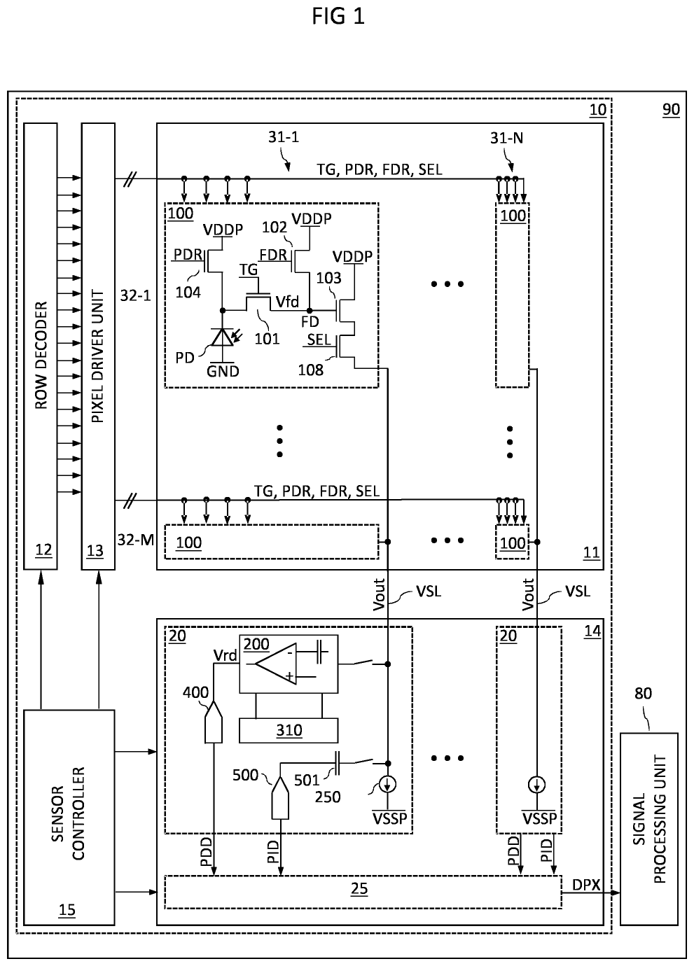

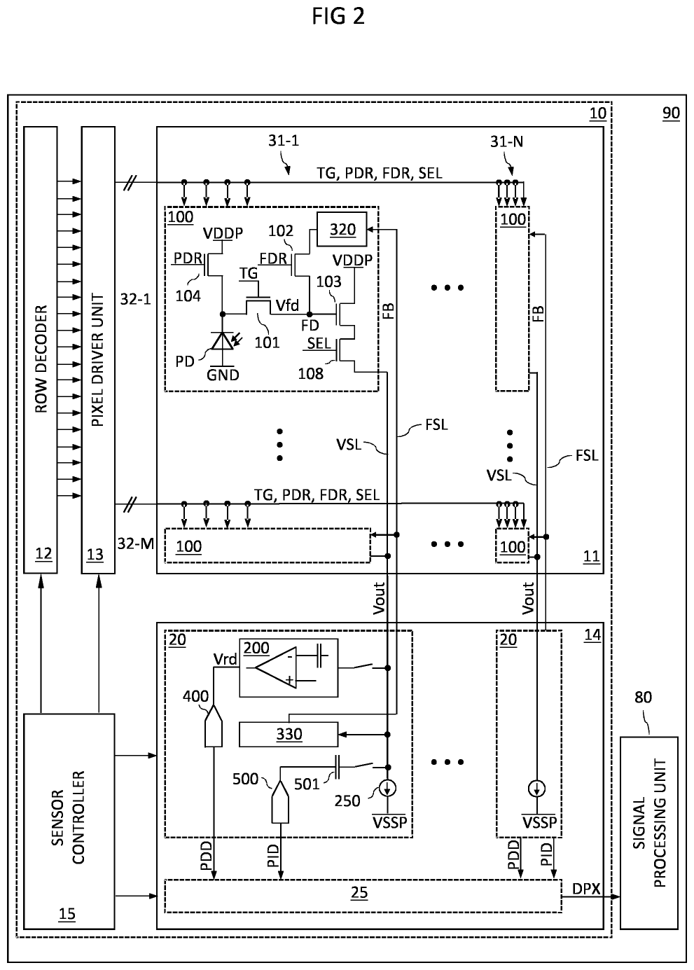

FIG. 1 and FIG. 2 illustrate configuration examples of a solid-state imaging device 90 including an image sensor assembly 10 and a signal processing unit 80 according to an embodiment of the present technology. The image sensor assembly 10 may include a pixel array unit 11, a row decoder 12, a pixel driver unit 13, a column signal processing unit 14, and a sensor controller 15.

The pixel array unit 11 includes a plurality of identical pixel circuits 100. The pixel circuits 100 may be any active pixel sensors for intensity readout with at least four FETs (field effect transistors). In the illustrated embodiment. each pixel circuit 100 includes one photoelectric conversion element PD and five FETs for controlling the output signal of the pixel circuit 100. Other embodiments may refer to pixel circuits 100 with more than five FETs, or with four FETs, and with pixel circuits 100 with two or more photoelectric conversion elements PD.

The photoelectric conversion elements PD of the pixel array unit 11 may be arranged matrix-like in columns and rows. A subset of pixel circuits 100 assigned to the same column of photoelectric conversion elements PD may form a pixel column 31-1, . . . , 31-N. A subset of pixel circuits 100 assigned to the same row of photoelectric conversion elements PD may form a pixel row 32-1, . . . , 32-M.

The row decoder 12 and the pixel driver unit 13 control driving of each pixel circuit 100 or each pixel row 32-1, . . . , 32-M disposed in the pixel array unit 11. In particular, the row decoder 12 may supply control signals for selecting the pixel circuits 100 of a selected pixel row 32-1, . . . , 32-M to the pixel driver unit 13 according to an address latch signal from the sensor controller 15. The pixel driver unit 13 may control the FETs of the selected pixel row 32-1, . . . , 32-M according to driver timing signals supplied from the sensor controller 15 and the control signals supplied from the row decoder 12.

The output signals of the pixel circuits 100 (pixel signals) of the same pixel column 31-1, . . . , 31-N are successively supplied to at least one data signal line (vertical signal line) VSL. Each data signal lines VSL passes the output signals of the pixel circuits 100 (pixel signals) of one of the pixel columns 31-1, . . . , 31-N to the column signal processing unit 14.

In particular, the solid-state imaging device 90 includes pixel circuits 100 arranged in pixel columns 31-1, . . . , 31-N, wherein each pixel column 31-1, . . . , 31-N is assigned to one data signal line VSL and wherein signal outputs of the pixel circuits 100 of the same pixel column 31-1, . . . , 31-N are connected to the same common data signal line VSL.

In each pixel circuit 100, the photoelectric conversion element PD photoelectrically converts incident electromagnetic radiation into electric charges. The amount of electric charge generated in the photoelectric conversion element PD corresponds to the intensity of the incident electromagnetic radiation. For example, the photoelectric conversion element PD may include or consist of a photodiode which converts electromagnetic radiation incident on a detection surface into a detector current by means of the photoelectric effect. The electromagnetic radiation may include visible light, infrared radiation and/or ultraviolet radiation. The amplitude of the detector current corresponds to the intensity of the incident electromagnetic radiation, wherein in the intensity range of interest the detector current increases approximately linearly with increasing intensity of the detected electromagnetic radiation.

In addition to the photoelectric conversion element PD, the illustrated configuration example of the pixel circuit 100 includes a floating diffusion region FD for storing charge supplied from the photoelectric conversion element PD, a PD reset transistor 104, a transfer transistor 101, an FD reset transistor 102, an amplification transistor 103, and a selection transistor 108. Each of the transistors is or includes an FET.

A load path of the PD reset transistor (photodetector reset transistor) 104 is electrically connected between a positive pixel supply potential VDDP and a cathode of the photoelectric conversion element PD. The PD reset transistor 104 serves as a reset element that precharges the cathode of the photoelectric conversion element PD. A PD reset signal PDR is supplied to the gate of the PD reset transistor 104 through a PD reset control line. The PD reset signal PDR has an active signal level and an inactive signal level. In particular, an active PD reset signal PDR sets the potential at the cathode of photoelectric conversion element PD equal to or approximately equal to the positive pixel supply potential VDDP.

A load path of the transfer transistor 101 is electrically connected between the cathode of the photoelectric conversion element PD and the floating diffusion region FD. The transfer transistor 101 serves as transfer element for transferring charge from the photoelectric conversion element PD to the floating diffusion region FD. The floating diffusion region FD serves as temporary local charge storage. A transfer signal TG is supplied to the gate (transfer gate) of the transfer transistor 101 through a transfer control line. The transfer signal TG has an active signal level and an inactive signal level. In response to an active transfer signal TG, the transfer transistor 101 may transfer electrons photoelectrically converted by the photoelectric conversion element PD to the floating diffusion region FD.

A load path of the FD reset transistor (floating diffusion reset transistor) 102 is electrically connected between a positive pixel reset voltage Vres and the floating diffusion region FD. The FD reset transistor 102 serves as a reset element that resets a floating diffusion potential Vfd of the floating diffusion region FD. An FD reset signal RFD is supplied to the gate of the FD reset transistor 102 through a reset control line. The FD reset signal RFD has an active signal level and an inactive signal level. In particular, an active FD reset signal RFD sets the floating diffusion potential Vfd equal to or approximately equal to the pixel reset voltage Vres. The pixel reset voltage Vres may be a fixed voltage, e.g, a positive pixel supply voltage VDDP, or may be adaptive and controlled by a threshold drift compensation circuit.

The floating diffusion region FD is connected to the gate of the amplification transistor 103 serving as an amplification element. The floating diffusion region FD functions as the input node of the amplification transistor 103.

The amplification transistor 103 and the selection transistor 108 are connected in series between the positive pixel supply voltage VDDP and the data signal line VSL. Thus, the amplification transistor 103 is connected to the data signal line VSL through the selection transistor 108. A row select signal SEL is supplied to the gate of the selection transistor 108 through a select control line. The row select signal SEL has an active signal level and an inactive signal level.

An active row select signal SEL turns on the selection transistor 108 for a row selection interval. When the selection transistor 108 is on, the amplification transistor 103 operates in a source-follower configuration and outputs pixel signal to the data signal line VSL at a voltage level dependent on the current floating diffusion potential Vfd. The data signal line VSL passes the pixel signals Vout from the pixel circuit 100 to the column signal processing unit 14.

During the same row selection interval, the pixel circuit 100 outputs at least two different pixel signals having different image contents recorded at different times, wherein for an earlier pixel signal (previous pixel signal) the photoelectric conversion element PD of the pixel circuit 100 is exposed at an earlier time, e.g, during an earlier row selection interval, than for a later pixel signal (new pixel signal).

Since the respective gates of the transfer transistor 101, the PD reset transistor 104, the FD reset transistor 102, and the selection transistor 108 are connected in units of pixel rows 32-1, . . . , 32-M, these operations can be simultaneously performed for each of the pixel circuits 100 of one pixel row 32-1, . . . , 32-M.

Each data signal line VSL is further connected to at least one of the signal conversion units 20. Each signal conversion unit 20 includes constant current circuits 250, wherein each constant current circuit 250 is electrically connected between a data signal line VSL and a negative pixel supply potential VSSP. Each constant current circuit 250 may include a constant current source or a switched capacitor current source supplying at least temporarily a constant current to the data signal line VSL.

The amplification transistor 103 of a pixel circuit 100 connected to a data signal line VSL and the constant current circuit 250 connected to the data signal line complement to a source follower circuit passing the pixel signal Vout controlled by the floating diffusion potential Vfd to the column signal processing unit 14.

The column signal processing unit 14 may include one or more signal conversion units 20. Each signal conversion unit 20 converts signals derived from the analog pixel signals Vout into digital data. The column signal processing unit 14 may include as many signal conversion units 20 as the pixel array unit 11 includes data signal lines VSL. Alternatively, the number of signal conversion units 20 may be less than the number of data signal lines VSL and each signal conversion unit 20 may be multiplexed between two or more of the data signal lines VSL. In particular, one data signal line VSL may connect a signal conversion unit 20 with all pixel circuits 100 of the same pixel column 31-1, . . . , 31-No.

Each signal conversion unit 20 includes a differencing circuit 200. From each pixel circuit 100 connected to the same data signal line VSL, the differencing circuit 200 successively receives a previous pixel signal and a new pixel signal within the same row selection interval. From the two successively received pixel signals, the differencing circuit 200 generates a difference signal Vrd. The difference signal Vrd may be an analog difference signal, wherein a voltage level of the analog difference signal Vrd is a function of a voltage difference between the previous pixel signal and the new pixel signal, or may be a binary difference signal indicating whether or not the voltage difference fulfills a predetermined requirement.

A converter circuit 400 obtains digital pixel differencing data PDD from the difference signal Vrd. The pixel differencing data PDD may include difference data obtained by AD conversion of an analog difference signal Vrd, and/or event information, by way of example. The differencing circuit 200 and/or the converter circuit 400 may be activated in response to an active differencing control signal and deactivated in response to an inactive differencing control signal.

In addition, each signal conversion unit 20 may include an ADC unit 500 that performs analog-to-digital conversion of single pixel signals (Vout) and outputs digital pixel intensity data PID. The ADC unit 500 may be activated in response to an active ADC control signal and may be deactivated in response to an inactive ADC control signal.

A readout buffer circuit 25 receives the pixel differencing data PDD and/or the pixel intensity data PID.

The sensor controller 15 controls the column signal processing unit 14. In particular, the sensor controller 15 may synchronize the AD conversion in the ADC units 500 and the differencing operation in the differencing circuits 200 with the control signals of the pixel circuits 100. In addition, the sensor controller 15 may generate a readout control signal that controls the readout of the pixel differencing data PDD and/or the pixel intensity data PIC from the readout buffer circuit 25 to, e.g., the signal processing unit 80.

The image sensor assembly 10 may further include a noise reduction circuit. The noise reduction circuit may include dual sample circuits 310, kTC noise reduction circuits 320, and threshold drift compensation circuits 330.

FIG. 1 shows one dual sample circuit 310 per pixel column. The dual sample circuit 310 is completely integrated in the signal conversion unit 20 of a pixel column 31-1, . . . , 31-N. For at least one of the previous pixel signal and the new pixel signal, or for both, a noise signal and a data signal are successively sampled and subtracted from each other, before the differencing operation between the previous pixel signal and the new pixel signal is performed. The dual sample circuit may reduce noise by CDS (correlated double sampling) and/or DDS (differential double sampling).

FIG. 2 shows one kTC noise reduction circuit 320 per pixel circuit 100 and one threshold drift compensation circuit 330 per pixel column. The threshold drift compensation circuit 330 is integrated in the signal conversion unit 20 of a pixel column 31-1, . . . , 31-N. Each kTC noise reduction circuit 320 is integrated in one of the pixel circuits 100. The threshold drift compensation circuit 330 generates a feedback signal FB on a feedback signal line FSL. The feedback signal line FSL may connect the output of the threshold drift compensation circuit 330 with inputs of the kTC noise reduction circuits 320.

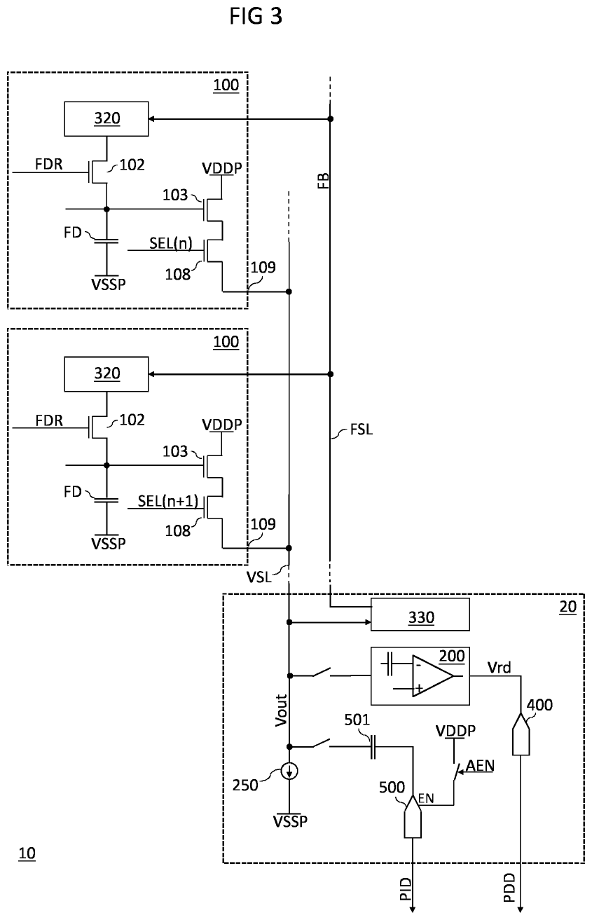

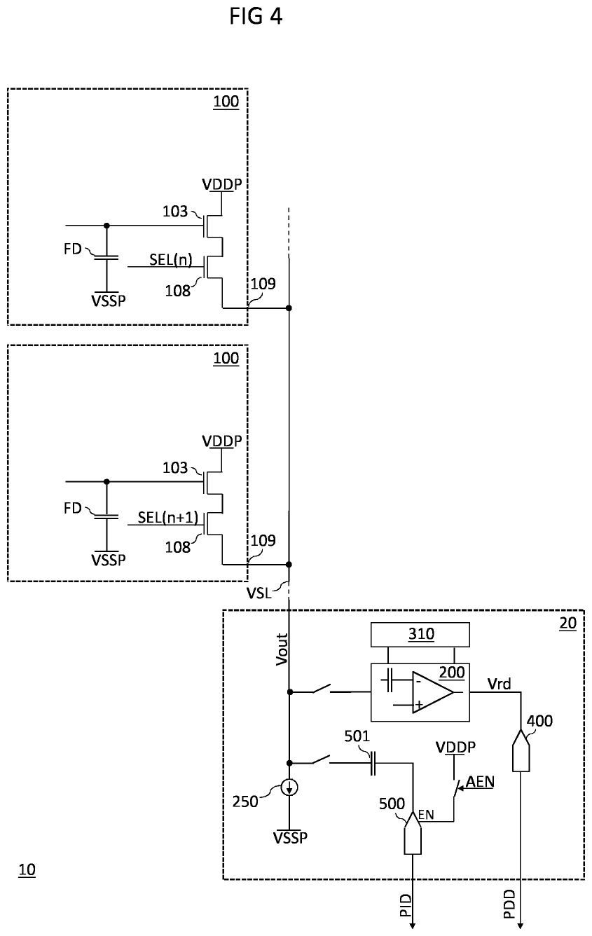

FIG. 3 and FIG. 4 show a part of an image sensor arrangement 10 with pixel circuits 100 and a differencing circuit 200. Each pixel circuit 100 outputs pixel signals Vout on a data signal line VSL in response to an active row select signal SEL in a row selection interval. Each pixel circuit 100 includes a floating diffusion FD, wherein a floating diffusion potential Vfd of the floating diffusion FD determines a voltage level of the pixel signals Vout. A differencing circuit 200 receives, for each of the pixel circuits 100, two pixel signals Vout successively transmitted from the pixel circuit 100 on the data signal line VSL within a same row selection interval, and obtains a difference signal Vrd from the two pixel signals. The solid-state imaging device 90 controls each pixel circuit 100 to output a previous pixel signal and a new pixel signal in a same row selection interval, wherein the previous pixel signal and the new pixel signal may contain image information about an imaged scene at different points in time.

The differencing circuit 200 is part of the pixel array unit 11 and an input of the differencing circuit 200 is directly connected to the data signal line VSL connected to pixel outputs of the pixel circuits 100 of the same pixel column.

In the same row selection interval, the differencing circuit 200 receives the previous pixel signal and the new pixel signal and obtains a difference signal Vrd from the two pixel signals, wherein the difference signal Vrd contains information about the voltage difference between the previous pixel signal and the new pixel signal.

Considering the information obtained from all pixel circuits 100 of the image sensor arrangement 10, the image sensor arrangement 10 is capable of outputting a frame-differenced image without elaborate digital processing in a downstream processor.

The difference signal Vrd may be an analog difference signal, wherein a voltage level of the analog difference signal Vrd is a function of a voltage difference between the two pixel signals Vout. Alternatively, the difference signal Vrd may be a binary signal indicating whether or not the difference between the pixel signals exceeds a certain threshold.

The pixel circuit 100 may be any pixel circuit suitable for intensity readout, provided that the pixel circuit 100 includes an output part with an amplification transistor 103 controlled by a floating diffusion potential Vfd of a floating diffusion FD and a selection transistor 108 for selectively connecting one selected pixel circuit 100 with the data signal line VSL.

A charge sampled by a photocurrent in an exposure time is transferred to the floating diffusion FD sometime after the exposure time has elapsed. The floating diffusion potential Vfd is applied to a gate of the amplification transistor 103. A row select signal SEL is applied to a gate of the selection transistor 108. Load paths of the amplification transistor 103 and the selection transistor 108 are electrically connected is series between a positive pixel supply potential VDDP and a pixel output 109. The data signal line VSL electrically connects the pixel outputs 109 of a plurality of identical pixel circuits 100 of the same pixel column. A constant current circuit 250 is connected between the data signal line VSL and a negative pixel supply potential VDDP. The amplification transistor 103 and the constant current circuit 250 complement each other to form a source follower circuit, when the selection transistor 108 is on during a row selection interval.

In particular, the solid-state imaging device controls the floating diffusion FD to keep a floating diffusion potential Vfd from a readout of a new pixel signal in a first row selection interval for a pixel circuit 100 until a readout of a previous pixel signal in a second row selection interval for the pixel circuit 100.

The first and second row selection intervals are successive row selection intervals for the same pixel row. The time interval between the first and second row selection intervals is approximately the reciprocal of the frame rate.

The floating diffusion FD is designed such that a leakage current from the floating diffusion within a time period between two readouts of the same pixel row is negligible.

The differencing circuit 200 may include an amplifier circuit 205, a sample capacitor 201 in a first input leg between the data signal line VSL and an inverting input of the amplifier circuit 205, and a switchable feedback path 202 between an output of the amplifier circuit 205 and the inverting input of the amplifier circuit 205.

The solid-state imaging device 90, e.g, the sensor controller 15 illustrated in FIG. 2, may control the differencing circuit 200 to sample a voltage corresponding to a signal level of a first pixel signal across the sample capacitor 201 in a first phase, and to obtain an analog difference signal Vrd from a difference between the voltage sampled at the sample capacitor 201 and a voltage level of a second pixel signal applied to an input electrode of the sample capacitor 201 in a second phase.

In particular, the amplifier circuit 205, the sample capacitor 201 and the switchable feedback path 202 may be used for directly comparing a previous pixel signal and a new pixel signal, or may be used for double sampling, e.g., to subtract a pixel noise signal from a pixel data signal for the previous pixel signal and/or for the new pixel signal.

The differencing circuit 200 and the constant current circuit 250 may be part of a signal conversion unit 20 connected to the data signal line VSL. The signal conversion unit 20 further includes an ADC unit 500 that performs analog-to-digital conversion of single pixel signals Vout and outputs digital pixel intensity data PID. The ADC unit 500 may be activated in response to an active ADC control signal AEN and deactivated in response to an inactive ADC control signal AEN. When deactivated, the ADC unit 500 typically consumes only a negligible amount of electric energy.

The signal conversion unit 20 may further include a converter circuit 400 that obtains digital pixel differencing data PDD from the difference signal Vrd. The pixel differencing data PDD may include difference data obtained by AD conversion of the analog difference signal, and/or event information, by way of example.

In FIG. 3, the pixel circuits 100 include FD reset transistors 102 for resetting a potential of the floating diffusion FD in response to an active FD reset signal. The image sensor assembly 10 further includes kTC noise reduction circuits 320 and a threshold drift compensation circuit 330. The kTC noise reduction circuit 320 reduces kTC noise generated in the floating diffusion FD by turning off the FD reset transistor 102. To this end, the kTC noise reduction circuit 320 provides a parallel capacitive path for charge carriers when the FD reset transistor 102 turns off, and later turns off the parallel capacitive path such that kTC noise is partly generated in a node which has less impact on the pixel signals and only part of the kTC noise is generated in and/or transferred to the floating diffusion FD.

The threshold drift compensation circuit 330 compensates fluctuations in the threshold voltage of the amplification transistor 103 by adjusting, separately for each pixel circuit 100, the reset voltage of the floating diffusion FD in dependence on the voltage level on the data signal line VSL when the floating diffusion FD is reset.

In FIG. 4, the image sensor assembly 10 includes a double sampling circuit 310 that reduces noise by applying a double sampling method like CDS (correlated double sampling) and/or DDS (differential double sampling). The double sampling methods rely on a double readout of the same pixel circuit 100, once after the floating diffusion FD receives the charge generated in course of an exposure and before FD reset, and once after FD reset and before the floating diffusion FD receives the charge generated in course of an exposure, or vice versa.

In particular, each readout of a pixel circuit 100 includes two intervals: In a first period (data phase, D phase), a first pixel signal (data signal) is read out after the floating diffusion FD has received the charge generated in an exposure time, and sampled. In a second period (preset phase, P phase), a second pixel signal (noise signal) of the non-illuminated pixel is read out, e.g, after FD reset and before the floating diffusion FD receives charge generated in an exposure time. The second period may directly precede or may directly follow the first period. The final pixel output value is obtained by subtracting the second pixel signal (noise signal) from the sampled first pixel signal (data signal), wherein noise effects on the final pixel output value can be reduced. According to a CDS readout method, the P phase precedes the D phase. In a DDS readout method, the D phase precedes the P phase.

Operation of the dual sample circuit 310 and the differencing circuit 200 may be intertwined and the dual sample circuit 310, the differencing circuit 200, and/or the pixel circuit 100 may share some resources, e.g, one or more circuit elements, wherein a shared circuit element fulfills different tasks for the different circuits.

The dual sample circuit 310 can be completely formed as part of the signal conversion unit 20. Noise reduction without feedback to the pixel circuits 100 may allow faster operation, e.g., faster frame readout.

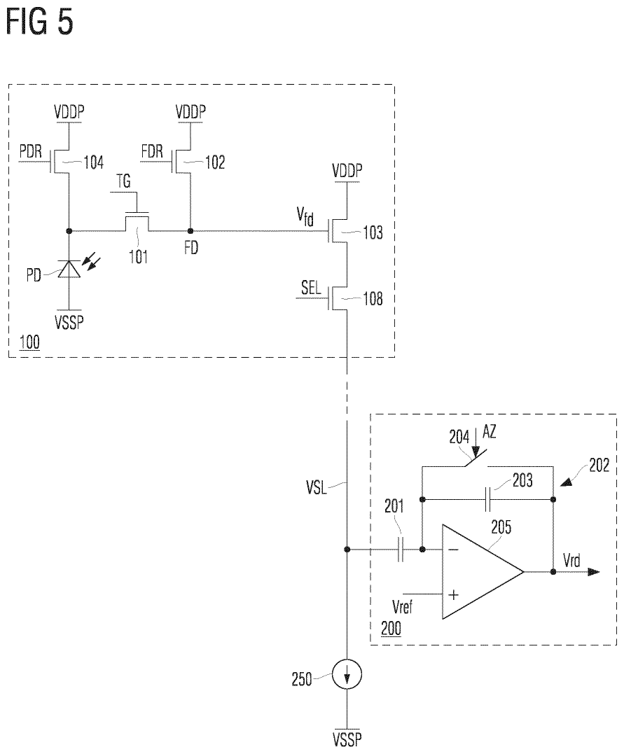

In FIG. 5 and further embodiments, the pixel circuit 100 is based on a floating diffusion FD whose floating diffusion potential Vfd determines a voltage level of the pixel signals Vout.

The pixel circuit 100 may further include a photoelectric conversion element PD that determines the floating diffusion potential Vfd by photocurrent, and a transfer transistor 101 that connects a cathode of the photoelectric conversion element PD and the floating diffusion FD in response to an active transfer signal TG in the row selection interval. The transfer transistor 101 may allow to output two pixel signals resulting from two successive exposures, provided a leakage current from the floating diffusion is sufficiently low.

The pixel circuit 100 may further include a photodetector reset transistor 104 that resets a potential at the cathode of the photoelectric conversion element PD to a fixed potential in response to an active photodetector reset signal PDR. The photodetector reset transistor 104 gives more leeway for determining the length of the exposure time.

In addition, the pixel circuit 100 may include a floating diffusion reset transistor 102 that connects the floating diffusion FD with a pixel reset voltage Vres in response to at least an active floating diffusion reset signal FDR. The reset of the floating diffusion FD may be controlled exclusively by the floating diffusion reset signal FDR or in combination with one or more other control signals. The pixel reset voltage Vres may be a fixed voltage, e.g, the positive pixel supply potential VDDP, or an adaptive voltage.

In FIG. 5, the differencing circuit 200 includes an amplifier circuit 205, a sample capacitor 201 electrically connected between the data signal line VSL and an inverting input of the amplifier circuit 205, and a switchable feedback circuit 202 between an output of the amplifier circuit 205 and the inverting input of the amplifier circuit 205.

The feedback circuit 202 includes a gain capacitor 203 electrically connected between the output of the amplifier circuit 205 (amplifier output) and the inverting input of the amplifier circuit 205 (inverting amplifier input). An autozero switch element 204 is electrically connected between the amplifier output and the inverting amplifier input. An active autozero signal AZ turns on the autozero switch element 204 and sets the potential at the inverting amplifier input to the potential applied to the non-inverting amplifier input. The potential applied to the non-inverting amplifier input may be fixed or variable.

The solid-state imaging device 90, in particular the sensor controller 15 of FIG. 2 controls the differencing circuit 200 to sample a voltage corresponding to a signal level of a previous pixel signal across the sample capacitor 201 in a first phase, and to obtain an analog difference signal Vrd from a difference between the voltage sampled at the sample capacitor 201 and a voltage level of a next pixel signal applied to an input electrode of the sample capacitor 201 in a second phase. The previous pixel signal and the new pixel signal contain image information about an imaged scene at different points in time.

The differencing circuit 200 uses the sample capacitor 201, the amplifier circuit 205, the gain capacitor 203, and the autozero switch element 204 for comparing the new pixel signal with the previous pixel signal.

The amplifier circuit 205 receives a constant reference voltage Vref at the non-inverting input.

The differencing circuit 200 is capable of successively receiving a previous and a new pixel signal from the same pixel circuit 100 within the same row selection interval, storing a voltage corresponding to the voltage level of the previous pixel signal across the sample capacitor 201 by setting the potential at the inverting amplifier input equal to the potential at the non-inverting amplifier input in the first phase, and subtracting the voltage across the sample capacitor 201 from the voltage level of the new pixel signal level by letting float the inverting amplifier input in the second phase. As a result, a the amplifier circuit 205 outputs an analog difference signal Vrd, wherein a voltage level of the analog difference signal Vrd is a function, in particular an almost linear function, of the difference between the signal levels of the previous pixel signal and the new pixel signal.

Inherently, the differencing circuit 200 uses the floating diffusions FD in the pixel circuits 100 as memory elements that for each pixel circuit 100 store new floating diffusion potentials corresponding to the new pixel signal until the pixel circuit 100 is addressed in the next frame, wherein in the next frame the former “new” floating diffusion potential Vfd becomes the next “previous” floating diffusion potential Vfd determining the next previous pixel output signal.

The differencing circuit 200 may of FIG. 5 be combined with various noise reduction circuits.

The solid-state imaging device may include a kTC noise reduction circuit configured to reduce kTC noise in the pixel signals prior to obtaining the difference signal Vrd.

In particular, each pixel circuit 100 may include a kTC noise reduction circuit 320 capable of reducing reset noise generated by charges getting stored in the floating diffusion FD each time the floating diffusion FD is separated from the positive pixel supply potential VDDP.

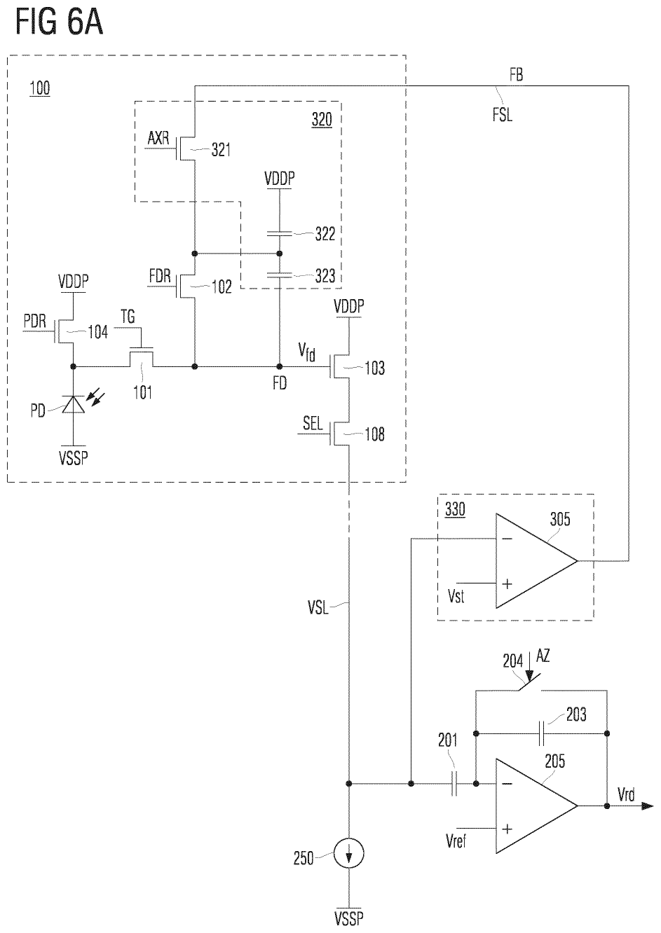

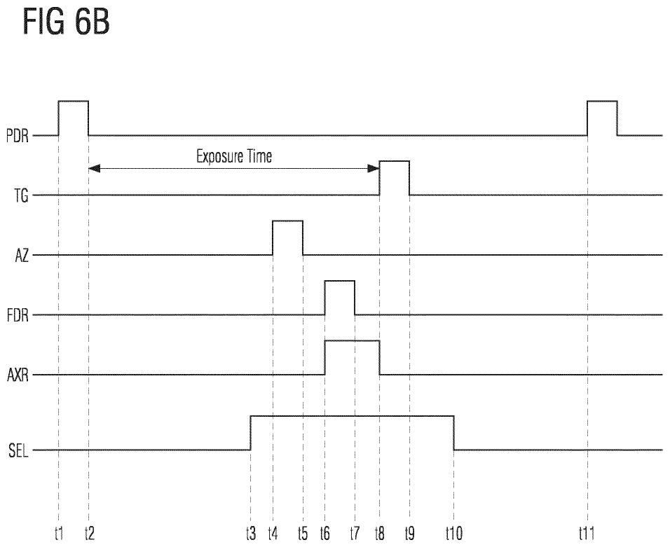

FIG. 6A combines the differencing circuit 200 of FIG. 5 with a kTC noise reduction circuit 320 and a threshold drift compensation circuit 330. The pixel circuit 100 is a 5T pixel including a PD reset transistor 104 controlled by a PD reset signal PDR.

The solid-state imaging device includes a threshold drift compensation circuit 330 that controls the pixel reset voltage Vres as a function of a current voltage of the pixel signal Vout on the data signal line VSL.

In particular, the threshold drift compensation circuit 330 may include a column feedback amplifier 305. The pixel signal Vout on the data signal line VSL is applied to an inverting input of the column feedback amplifier 305. A standard voltage Vst is applied to a non-inverting input of the column feedback amplifier 305. The standard voltage Vst serves as a reference for the pixel signal generated by the pixel circuit 100. For example, the standard voltage Vst may correspond to the expected signal level of the pixel signal of the non-illuminated pixel.

The column feedback amplifier 305 generates a feedback signal FB on a feedback signal line FSL. A voltage level of the feedback signal FB is a function of a difference between the pixel signal Vout and the standard voltage Vst. The feedback signal line FSL connects the output of the column feedback amplifier 305 with the kTC noise reduction circuits 320. The solid-state imaging device further includes kTC noise reduction circuits 320 integrated in the pixel circuits 100.

To this end, the pixel circuit 100 further includes an auxiliary transistor 321 and a pixel coupling capacitor 323. The auxiliary transistor 321 is electrically connected in series between the FD reset transistor 102 and a node supplying the pixel reset voltage Vres. The auxiliary transistor 321 connects the FD reset transistor 102 to the node supplying the pixel reset voltage Vres in response to an active auxiliary signal AXR. The pixel coupling capacitor 323 is electrically connected in parallel to the FD reset transistor 102.

In the illustrated embodiment, the auxiliary transistor 321 is electrically connected between the feedback signal line FSL and a side of the FD reset transistor 102 averted from the floating diffusion FD. An active auxiliary signal AXR turns on the auxiliary transistor 321.

Each kTC noise reduction circuit 320 may further include a pixel storage capacitor 322 electrically connected between a constant voltage, e.g., the positive pixel supply potential VDDP and the node between the FD reset transistor 102 and the auxiliary transistor switch 321, and a pixel coupling capacitor 323 electrically connected between the floating diffusion FD and the node between the FD reset transistor 102 and the auxiliary transistor 321. The capacitance of the pixel storage capacitor 322 may be in the same order of magnitude, e.g, approximately the same, as the capacitance of the floating diffusion FD. The capacitance of the pixel coupling capacitor 323 may be smaller than the capacitance of the floating diffusion FD.

When in a pixel circuit 100 without pixel coupling capacitor 323 the reset transistor 102 turns off, reset kTC noise is generated in the floating diffusion FD. The noise charge is a function of kTC, wherein k is the Boltzmann constant, T is the temperature and C is the capacitance of the floating diffusion FD. Reducing C of the floating diffusion FD would reduce the dynamic range of the pixel circuit 100. Instead, when the FD reset transistor 102 turns off in the pixel circuit 100 of FIG. 6A, the pixel coupling capacitor 323 and the auxiliary transistor 321 form an alternative path for charge carriers, provided the auxiliary transistor 321 is still on. When later the auxiliary transistor 321 turns off, comparatively low reset noise is generated in the floating diffusion FD.

The sensor controller 15 in FIG. 2 may control the select signal SEL, the PD reset signal PDR, the FD reset signal FDR, the transmit signal TG, and the auxiliary signal AXR according to the time diagram illustrated in FIG. 6B.

Between t=t1 and t=t2, a reset pulse in the PD reset signal PDR resets the potential on the cathode of the photoelectric conversion element PD to the positive pixel supply potential VDDP. The end of the reset pulse at t=t2 marks the start of the exposure time.

At t=t3, an active row select signal SEL turns on the selection transistor 108 and a previous pixel signal is applied to the data signal line VSL according to the previous floating diffusion potential Vfd. At the end of a short pulse in the autozero signal between t=t4 and t=t5, the voltage level of the previous pixel signal is sampled across the sample capacitor 201. Starting from t=t5, the non-inverting input of the amplifier circuit 205 floats and the difference signal Vrd at the output of the amplifier circuit 205 is a function of a voltage difference between the current signal on the data signal line VSL and the previous pixel signal.

At t=t6, both the FD reset signal FDR and the auxiliary signal AXR become active. The FD reset transistor 102 and the auxiliary transistor 321 turn on and connect the floating diffusion FD with the feedback signal line FSL, wherein the floating diffusion FD is set to a reset potential that compensates to some degree a temperature drift and/or pixel-to-pixel variations of the threshold voltage of the amplification transistor 103.

At t=t7, first the FD reset signal FDR becomes inactive and turns off the FD reset transistor 102. No or only low reset noise is generated in the floating diffusion FD because of the parallel path through the coupling capacitor 323. Then, at t=18 the auxiliary signal AXR becomes inactive and turns off the auxiliary transistor 321, wherein the floating diffusion is finally switched free without generating significant reset noise in the floating diffusion FD.

Between t=t8 and t=t9, the transfer transistor 101 turns on and connects the floating diffusion FD with the cathode of the photoelectric conversion element PD. The exposure time for the new pixel signal ends at t=t8. After t=19 the pixel circuit 100 outputs the new pixel signal which shows only low kTC noise.

The new pixel signal is available on the data signal line VSL until t=t10 when the pixel circuit 100 is deselected. Between t=t9 and t=t10, a voltage level of the analog difference signal Vrd is a function, in particular an almost linear function, of the difference between the signal levels of the previous pixel signal and the new pixel signal. A converter circuit 400 as illustrated in FIG. 2 may latch the difference signal Vrd between t=19 and t=t10.

The floating diffusion FD stores the floating diffusion potential Vfd for the new pixel signal until the next pixel circuit readout, at which time the former new pixel signal becomes the new previous pixel signal.

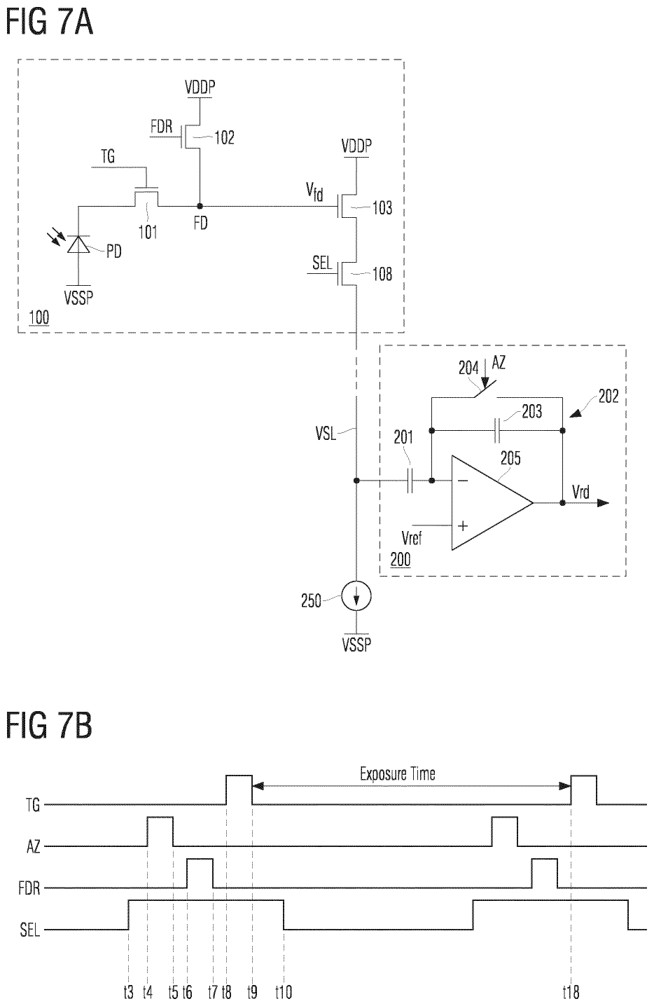

The pixel circuit 100 of FIG. 7A differs from the pixel circuit in FIG. 5 in that the PD reset transistor 104 is missing. Accordingly, the exposure time is determined by the temporal distance between two successive pulses in the transfer signal TG as illustrated in FIG. 7B. The pixel circuit 100 can be used in combination with any of the differencing circuits 200 of the present disclosure provided that the exposure time can be constant and equivalent to the reciprocal of the frame rate.

As described above, the solid-state imaging device 90, e.g, the sensor controller 15 illustrated in FIG. 2, may control the differencing circuit 200 to sample a voltage corresponding to a signal level of a first pixel signal across the sample capacitor 201 in a first phase, and to obtain the analog difference signal Vrd from a difference between the voltage sampled at the sample capacitor 201 and a voltage level of a second pixel signal applied to an input electrode of the sample capacitor 201 in a second phase.

While in the preceding embodiments the differencing circuit 200 compares the new pixel signal as the second pixel signal with the previous pixel signal as the first pixel signal, the following embodiments use the same elements for a double sampling to obtain noise-reduced versions of the previous pixel signal and/or the new pixel signal.

In particular, the first pixel signal is a pixel noise signal for a pixel signal and the second pixel signal is a pixel data signal for the pixel signal, or the first pixel signal is a pixel data signal for the pixel signal and the second pixel signal is a pixel noise signal for the pixel signal, wherein the pixel noise signal originates from an unexposed pixel and the pixel data signal originates from an exposed pixel.

In other words, the pixel noise signal corresponds to the pixel output signal of the unexposed (dark) pixel, and the pixel data signal corresponds to the pixel output signal of an arbitrarily exposed (bright pixel), wherein the pixel data signal contains noise.

The pixel signal may be the new pixel signal or the previous signal. Alternatively, the approach is used for both the new pixel signal and the previous signal separately, as it is the case for the next embodiment.

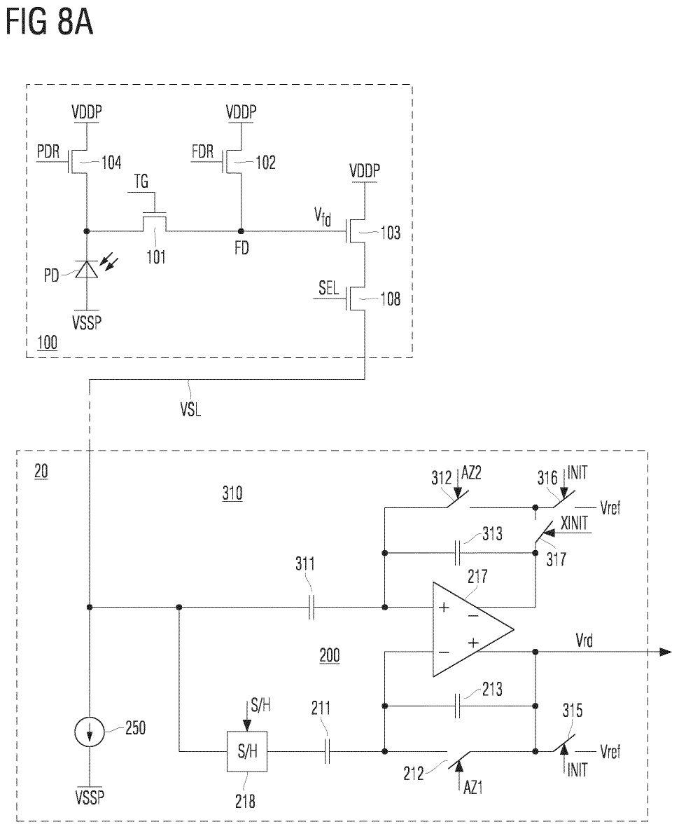

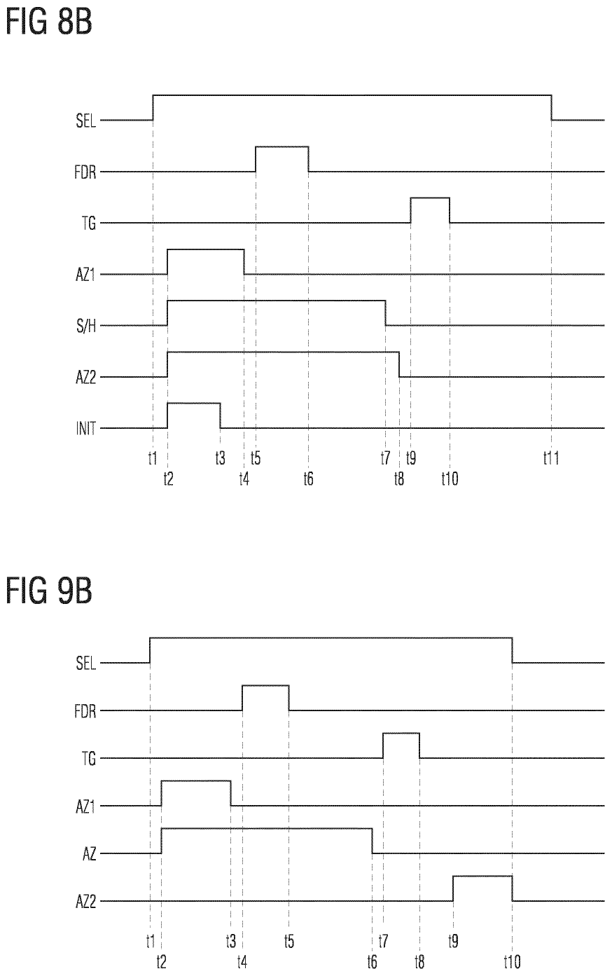

FIG. 8A refers to an embodiment with a differencing circuit 200 that includes a fully differential amplifier 217 and a sample/hold circuit 218 electrically connected in a first input leg between the data signal line VSL and a first input of the fully differential amplifier 217. A second input leg couples the data signal line VSL and a second input of the fully differential amplifier 217.

The fully differential amplifier 217 is a high-gain electronic voltage amplifier with differential inputs and differential outputs. The first input of the fully differential amplifier 217 (first amplifier input) may be the inverting one of the differential inputs. The second input of the fully differential amplifier 217 (second amplifier input) may be the non-inverting one of the differential inputs. A first output of the fully differential amplifier 217 (first amplifier output) may be the inverting one of the differential outputs. A second output of the fully differential amplifier 217 (second amplifier output) may be the non-inverting one of the differential outputs. The differential output signal directly provides the analog difference signal Vrd.

A sample/hold signal S/H controls the sample/hold circuit 218. An active sample/hold signal S/H controls the sample/hold circuit to pass a signal present on the data signal line VSL to the output of the sample/hold circuit 218. When the sample/hold signal becomes inactive, the output of the sample/hold circuit 218 is separated from the input and from the data signal line VSL.

In a first pixel signal phase, the data signal line VSL passes a previous pixel signal to the sample/hold circuit 218 and the sample/hold circuit 218 passes the previous pixel signal to the first amplifier input. For a second pixel signal phase, the sample/hold circuit 218 interrupts the path between the data signal line VSL and the first amplifier input such that in the second pixel phase, a new pixel signal is passed only to the second amplifier input.

The fully differential amplifier 217 is embedded in a local feedback circuitry such that the fully differential amplifier 217 outputs an analog difference signal Vrd with a voltage level that is a function of the difference between the signal levels at the first and second amplifier inputs.

A dual sample circuit 310 modifies the previous and the new pixel signals before the analog difference signal Vrd is processed.

To this end, the solid-state imaging device includes a first sample capacitor 211 in a portion of the first input leg between the sample/hold circuit 218 and the first input of the differential amplifier circuit 217, a second sample capacitor 311 in the second input leg between the data signal line VSL and the second input of the differential amplifier circuit 217, a first gain capacitor 213 in a first feedback path between a second amplifier output and the first amplifier input, and a second gain capacitor 313 in second feedback path between a first amplifier output and the second amplifier input.

The first and second gain capacitors 213, 313 may be resettable, wherein the electrodes of the first gain capacitor 213 are temporarily short-circuited, and wherein the electrodes of the second gain capacitor 313 are temporarily short-circuited.

The first sample capacitor 211 and the first gain capacitor 213 facilitate a double sampling of the previous pixel signal by sequentially applying a pixel data signal for the previous pixel signal and a pixel noise signal for the new pixel signal to an input electrode of the first sample capacitor 211 and subtracting the pixel noise signal from the pixel data signal by an intermediate reset of the potential at the first amplifier input.

The second sample capacitor 311 and the second gain capacitor 313 facilitate a double sampling of the new pixel signal by sequentially applying a pixel noise signal and a pixel data signal for the new pixel signal to an input electrode of the second sample capacitor 311 and subtracting the pixel noise signal from the pixel data signal by an intermediate reset of the potential at the second amplifier input. The pixel noise signal for the new pixel signal is used for both DDS with the pixel data signal for the previous pixel signal and CDS with the pixel data signal for the new pixel signal.

The fully differential amplifier 217 is part of both the differencing circuit 200 and a double sampling circuit 310.

For resetting the first and second gain capacitors 213, 313 and for initialization of the differencing circuit 200, the double sampling circuit 310 includes a first autozero switch 212 between the second amplifier output and the first amplifier input, and a second autozero switch 312 between the first amplifier output and the second amplifier input. An active first autozero signal AZ1 turns on the first autozero switch 212 and resets the potential at the first amplifier input with the potential at the second amplifier output. An active second autozero signal AZ2 turns on the second autozero switch 312 and resets the potential at the second amplifier input with reference potential Vref.

A first initialization switch 315 is connected between the second amplifier output and a reference potential Vref, and a second initialization switch 316 is connected between the first amplifier output and the reference potential Vref. A first side of a third initialization switch 317 is connected to the second autozero switch 312 and the second initialization switch 316. A second side of the third initialization switch 317 is connected to the second gain capacitor 313 and the first amplifier output. An active initialization signal INIT turns on the first initialization switch 315 and turns off the third initialization switch 317, wherein the potential at the first amplifier input is reset to the reference potential Vref provided the first autozero switch 212 is on. In addition, the active initialization signal INIT turns on the second initialization switch 316 and resets the potential at the second amplifier input with the reference potential Vref provided the second autozero switch 312 is on.

The sensor controller 15 in FIG. 1 may control the select signal SEL, the FD reset signal, the transmit signal TG, the initialization signal INIT, the first auto zero signal AZ1, the second autozero signal AZ2, and the sample/hold signal S/H according to the time diagram illustrated in FIG. 8B.

At t=t1, an active row select signal SEL turns on the selection transistor 108 and a pixel data signal for a previous pixel signal is applied to the data signal line VSL.

At t=t2, the initialization signal INIT, the first autozero signal AZ1, the second autozero signal AZ2 and the sample/hold signal S/H become active. The potentials at the first amplifier input and the second amplifier input are reset to the reference potential Vref. The sample/hold circuit 215 becomes transparent and the pixel data signal for the previous pixel signal is applied to the first sample capacitor 211. A voltage corresponding to a difference between the voltage level of the pixel data signal of the previous pixel signal and the reference voltage drops across the first sample capacitor 211.

At t=t3, the initialization signal INIT becomes inactive and the first and second initialization switches 315, 316 turn off. When at t=t4, the first autozero signal AZ1 gets inactive, the first autozero switch 212 turns off and the potential at the first amplifier input begins to float.

In the pixel circuit 100, an active FD reset pulse between t=15 and t=t6 sets the floating diffusion potential Vfd to a reset voltage. The pixel circuit 100 outputs the pixel noise signal for the new pixel signal. The resulting potential on the floating first amplifier input is a function of the difference between the signal levels of the pixel data signal and the pixel noise signal for the previous pixel signal. In this way, the part of the double sampling circuit connected to the first amplifier input performs differential double sampling for the previous pixel signal by using the pixel data signal for the previous pixel signal and the pixel noise signal for the new pixel signal.

With the falling edge of the sample/hold signal S/H at t=t7, the sample/hold circuit 215 decouples the first amplifier input from the data signal line VSL. The potential resulting from DDS of the previous pixel signal is maintained at the first amplifier input.

In the meantime, the same pixel noise signal is applied to the second sample capacitor 311. When at t=18 the second autozero signal AZ2 gets inactive, the second autozero switch 312 turns off, the potential at the second amplifier input begins to float, and a voltage drop corresponding to the voltage level of the pixel noise signal is sampled across the second sample capacitor 311. This pixel noise signal is considered as the noise component of the new pixel.

An active transfer signal TG between t=t9 and t=10 connects the cathode of the photoelectric conversion element PD and the floating diffusion FD. The pixel circuit 100 outputs the pixel data signal for the new pixel signal. The resulting potential on the floating second amplifier input in the differencing circuit 200 is a function of the difference between the signal levels of the pixel data signal and the pixel noise signal for the new pixel signal. In this way, the part of the noise reduction circuit connected to the second amplifier input performs correlated double sampling for the new pixel signal by using the pixel data signal for the new pixel signal and the pixel noise signal for the new pixel signal.

At t=t11 the select signal becomes inactive. Between t=t10 and t=t11 the fully differential amplifier outputs an analog difference signal with a voltage level that is a function, e.g, an almost linear function, of the difference of the voltage levels of the DDS corrected previous pixel signal and the CDS corrected new pixel signal.

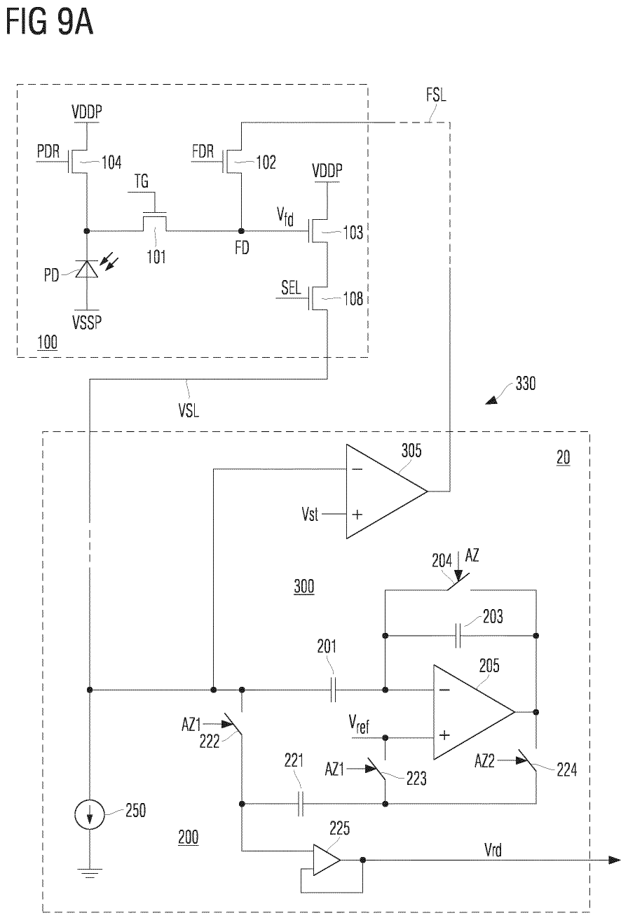

In FIG. 9A, the signal conversion unit 20 uses a differencing circuit 200 with sample capacitor 201, amplifier circuit 205, gain capacitor 203, and autozero switch element 204 as described with reference to FIG. 5 for noise reduction by double sampling.

The sample capacitor 201 receives the pixel signals at a first capacitor electrode (capacitor input electrode). A second capacitor electrode of the sample capacitor 201 is electrically connected to an inverting input of the amplifier circuit 205. A gain capacitor 203 is electrically connected between the output of the amplifier circuit 205 (amplifier output) and the inverting input of the amplifier circuit 205 (inverting amplifier input). The autozero switch element 204 is electrically connected between the amplifier output and the inverting amplifier input. An active autozero signal AZ turns on the autozero switch element 204 and sets the potential at the inverting amplifier input to the potential applied to the non-inverting amplifier input. The potential applied to the non-inverting amplifier input is switchable.

A supplemental sample capacitor 221 is in a path connecting the data signal line VSL and the non-inverting input of the amplifier circuit 205 (non-inverting amplifier input). A first sample switch element 222 is electrically connected between the data signal line VSL and a first electrode of the supplemental sample capacitor 221. An active first autozero signal AZ1 turns on the first sample switch element 222 and connects the supplemental sample capacitor 221 to the data signal line VSL.

A constant reference voltage Vref is applied to the non-inverting amplifier input. A second sample switch element 223 is electrically connected between the second electrode of the supplemental sample capacitor 221 and the non-inverting amplifier input. The active first autozero signal AZ1 turns on the second sample switch element 223 and connects the supplemental sample capacitor element 221 to the non-inverting amplifier input and the reference voltage Vref.

A second autozero switch element 224 is electrically connected between the amplifier output and the second electrode of the supplemental sample capacitor 221. An active second autozero signal AZ2 turns on the second autozero switch element 224 and sets the potential at the second electrode of the supplemental sample capacitor 221 to the potential at the amplifier output.

An input of an output buffer 225 is electrically connected to the first electrode of the supplemental sample capacitor 221 and outputs an analog difference signal Vrd that is a function, in particular an approximately linear function, of a voltage difference between a previous pixel signal and a new pixel signal.

The sensor controller 15 in FIG. 1 may control the select signal SEL, the FD reset signal FDR, the transmit signal TG, the auto zero signal AZ, the first autozero signal AZ1, and the second autozero signal AZ2 according to the time diagram illustrated in FIG. 9B.

At t=t1, an active row select signal SEL turns on the selection transistor 108 and a pixel data signal for a previous pixel signal is applied to the data signal line VSL.

At t=t2, the autozero signal AZ, and the first autozero signal AZ1 become active. The potential at the inverting amplifier input is reset to the reference potential Vref. The first sample switch element 222 and the second sample switch element 223 connect the supplemental sample capacitor 221 with the data signal line VSL and the non-inverting amplifier input.

At t=t3, the first sample switch element 222 and the second sample switch element 223 disconnect the supplemental sample capacitor 221 from the data signal line VSL and the non-inverting amplifier input, wherein the previous pixel signal is sampled in a voltage across the supplemental sample capacitor 221.

An active FD reset pulse between t=t4 and t=t5 sets the floating diffusion potential Vfd to a reset voltage obtained from the output of the column feedback amplifier 305 to compensate temperature-related fluctuations of the threshold voltage of the amplification transistor 103. After t=15, the pixel circuit 100 outputs the pixel noise signal for the new pixel signal.

When at t=t6 the autozero signal AZ gets inactive and the autozero switch 204 opens, the potential at the second amplifier input begins to float, and a voltage drop corresponding to the voltage level of the pixel noise signal is sampled across the sample capacitor 201.

An active transfer signal TG between t=t7 and t=18 connects the cathode of the photoelectric conversion element PD and the floating diffusion FD. The pixel circuit 100 outputs the pixel data signal for the new pixel signal. The resulting potential on the floating second amplifier input is a function of the difference between the signal levels of the pixel data signal and the pixel noise signal for the new pixel signal. In this way, the amplifier circuit 205, the sample capacitor 201, the gain capacitor 203 and the autozero switch element 203 in combination perform correlated double sampling for the new pixel signal, and the amplifier circuit 205 outputs the CDS corrected new pixel signal.

Between t=19 and t=t10, the amplifier output is connected to the second electrode of the supplemental sample capacitor 221. The voltage at the first electrode of the sample capacitor 211 corresponds to the difference between the amplifier output signal and the voltage sampled across the sample capacitor element 211 at t=t3. The buffer circuit 215 outputs a buffered output signal with a voltage level that is a function, e.g, an almost linear function, of the difference of the voltage levels of the previous pixel signal and the CDS corrected new pixel signal.

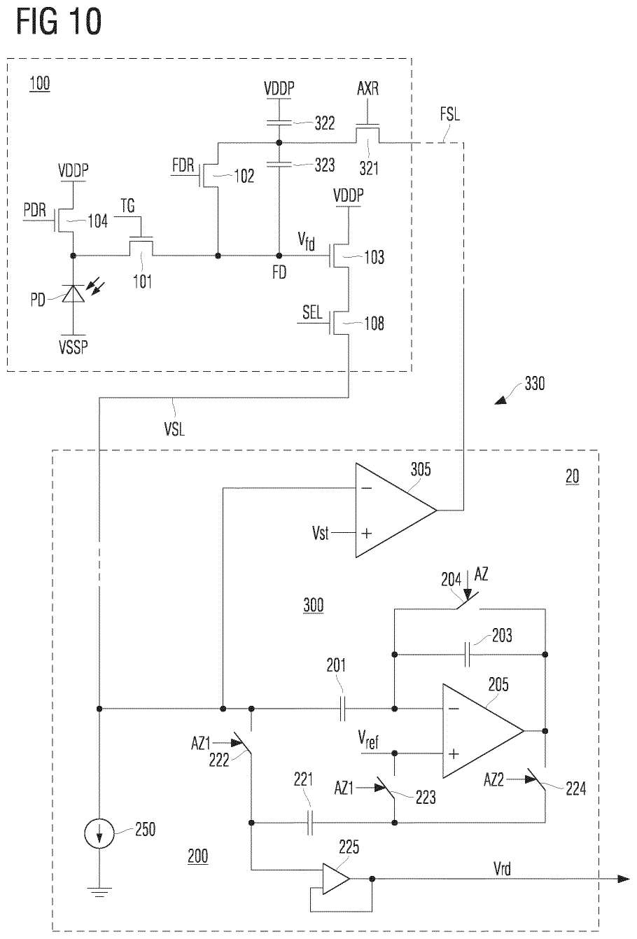

FIG. 10 shows a combination of the differencing circuit 200 with integrated CDS correction for the new pixel signal as shown in FIG. 9A with a kTC noise reduction circuit 320 as described with reference to FIG. 6A.

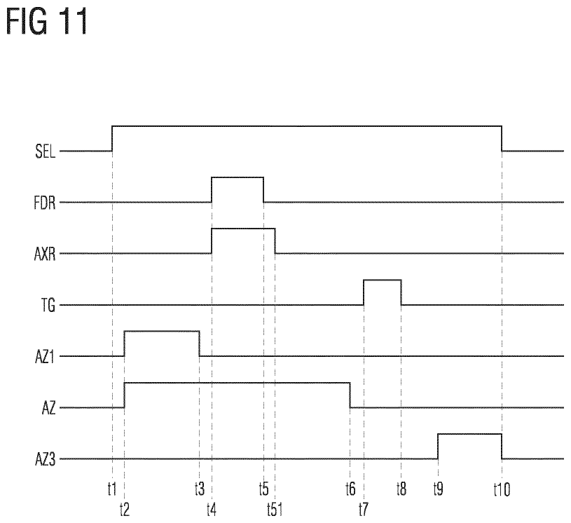

The sensor controller 15 in FIG. 1 may control the select signal SEL, the FD reset signal FDR, the auxiliary signal AXR, the transmit signal TG, the auto zero signal AZ, the first autozero signal AZ1, and the second autozero signal AZ2 according to the time diagram illustrated in FIG. 11.

The time diagram in FIG. 11 differs from that in FIG. 9B in that at t=t4 the auxiliary transistor 321 turns on simultaneously with the FD reset transistor 102 such that the floating diffusion potential Vfd is set to a reset voltage obtained from the feedback signal FB to compensate pixel-to-pixel variations and/or temperature-related fluctuations of the threshold voltage of the amplification transistor 103. When at t=t5 the FD reset transistor turns off, no or only low reset noise is generated in the floating diffusion FD due to the parallel path through the auxiliary transistor 321 and the pixel coupling capacitor 323. When at t=t51 the auxiliary transistor 321 turns off, only low reset noise is generated in the floating diffusion FD.

The analog difference signal Vrd may by AD converted by a typical ADC as used for intensity readout. For example, the same ADC may be switchable and may AD convert single pixel signals Vout in an intensity readout mode and may AD convert the analog difference signal Vrd in a frame differencing mode.

According to the following embodiments, the solid-state imaging device includes a converter circuit 400 that gates the difference signal Vrd with at least one threshold signal.

Each threshold signal may be a constant voltage, wherein the constant voltage may be fixed, configurable or adaptive. Alternatively, the threshold signal may vary with time. The converter circuit 400 enables preprocessing of the analog difference signal Vrd output from the differencing circuit 200 to computationally offload a downstream image processor.

According to an embodiment, the converter circuit 400 may obtain event information signal EV from the difference signal Vrd. To this end, the converter circuit 400 may gate the analog difference signal Vrd with two constant threshold voltages to obtain a digital event information signal. The two constant threshold voltages may be fixed voltage levels, or may be adapted during operation.

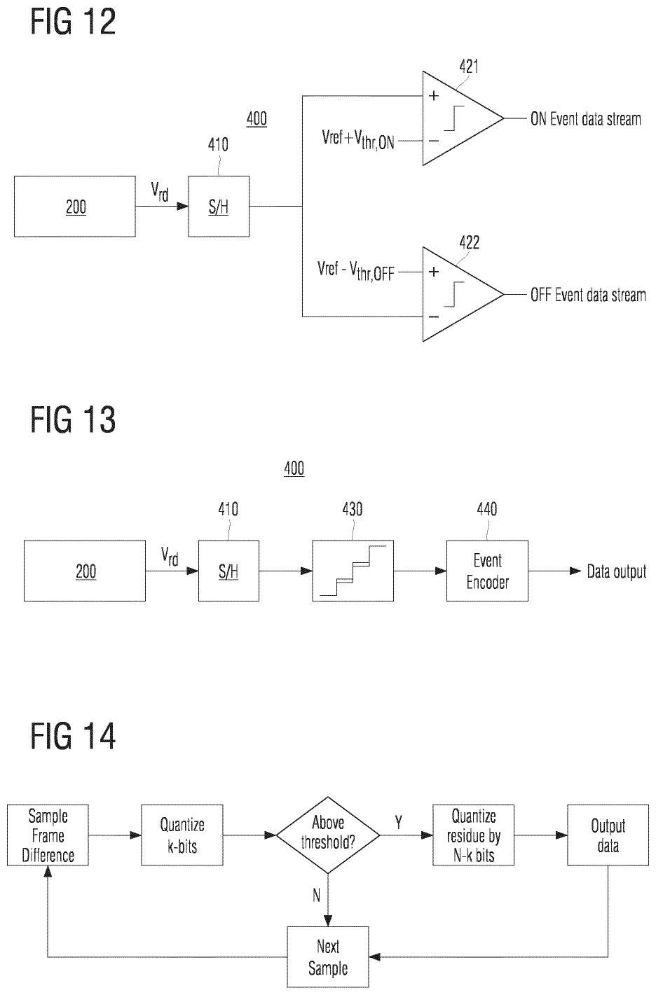

FIG. 12 shows a converter circuit 400 that includes a sample/hold portion 410 for latching the analog difference signal Vrd. A first comparator portion 421 compares the latched analog difference signal Vrd with a first threshold voltage. A binary output signal of the first comparator portion 421 has an active voltage level (“1”) only when the latched analog difference signal Vrd is higher than the first threshold voltage. A second comparator portion 422 compares the latched analog difference signal Vrd with a second threshold voltage. A binary output signal of the second comparator portion 422 has an active voltage level (“1”) only when the latched analog difference signal Vrd is lower than the second threshold voltage.

In FIG. 13, the converter circuit 400 includes a sample/hold portion 410, a low-resolution analog-to-digital converter 430 that converts the analog difference signal Vrd into a digital difference signal, and an event encoder 440. The analog-to-digital converter 430 may include a 2-bit quantizer circuit with adjustable threshold levels and detects a frame difference for the addressed pixel circuit 100 in either positive or negative direction above an adjustable threshold.

The event encoder 440 maps the result of the AD conversion to a digital event code. For example, a negative event may be encoded as “00”, a positive event as “11”. and no event as “01” and/or “10”. The event encoder 440 may output the encoded events in a data stream or may add the pixel address of the pixel circuit for which the event has been detected, such that the event encoder 440 outputs only pixel addresses and for each pixel address a data bit indicating the type of event.

FIG. 14 refers to another embodiment of a converter circuit 400 that includes an analog-to-digital converter 430. The solid-state imaging device 90 is configured to control the analog-to-digital converter 430 such that the difference signal Vrd is quantized with high accuracy only when after k out of N possible quantization steps the difference signal Vrd is above a predefined frame difference threshold.

Otherwise, the quantization is stopped. In this way, irrelevant or low-relevant quantization can be omitted and power consumption of the converter circuit can be reduced. The N possible quantization steps result from resolution of the analog-to-digital converter.

The output data may include pixel addresses combined with the quantized frame difference, or pixel addresses combined with a binary information (“0” or “1”) indicating whether or not the quantized frame difference exceeds the frame difference threshold.

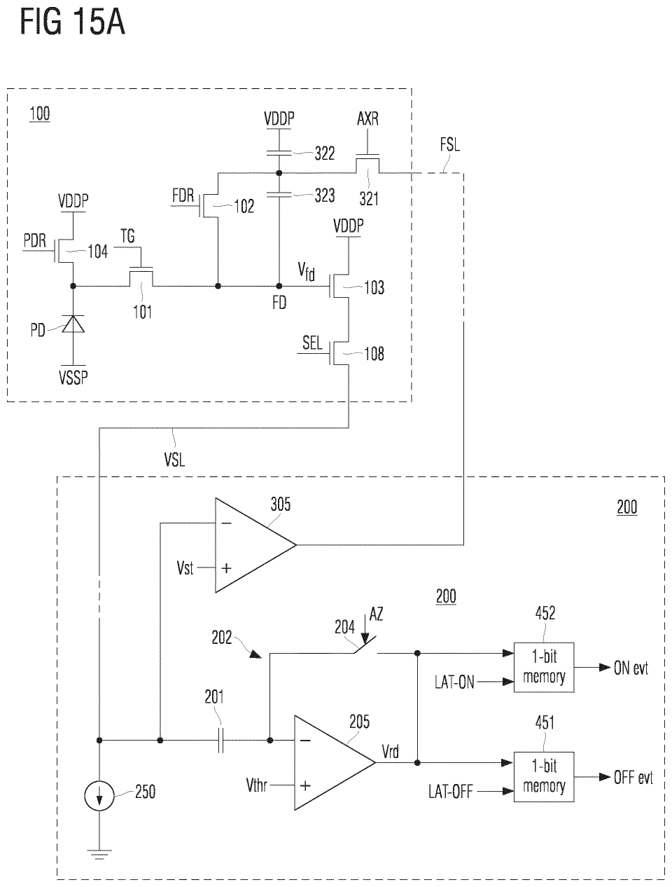

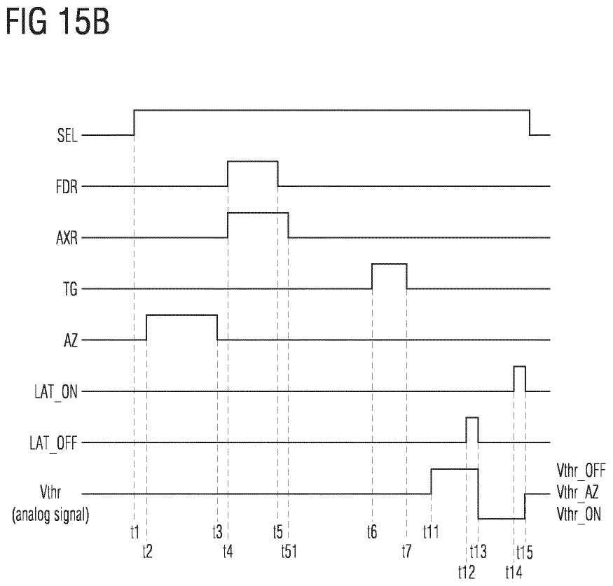

FIG. 15A refers to an embodiment with the amplifier circuit 205 outputting a binary difference signal Vrd.

The differencing circuit 200 includes an amplifier circuit 205, a sample capacitor 201 in a first input leg between the data signal line VSL and an inverting input of the amplifier circuit 205, 217, and an autozero switch element 204 between an output of the amplifier circuit 205 and the inverting input of the amplifier circuit 205. In addition, the differencing circuit 200 receives a variable threshold signal Vthr at the non-inverting input of the amplifier circuit 205. A gain capacitor 203 as described with reference to FIG. 5 may be omitted.

The variable threshold signal Vthr may be a digital signal whose voltage level changes between at least two different voltage levels, for example a ternary signal whose voltage level changes between three different voltage levels. When in the switchable feedback path 202 between the amplifier output and the inverting amplifier input the autozero switch element 204 is off, the amplifier output and the inverting amplifier input are completely separated and the feedback loop is open. The amplifier circuit 205 outputs a binary difference signal Vrd that indicates whether or not the voltage difference between the previous pixel signal and the new pixel signal exceeds of falls below a predetermined threshold that depends on the current voltage level of the variable threshold signal Vthr.

The converter circuit 400 includes a first one-bit memory 451 and a second one-bit memory 452 that successively latch the result of comparisons of the voltage difference between the previous pixel signal and the new pixel signal.

As illustrated in FIG. 15B, the first one-bit memory 451 latches the result of the comparison with a positive or higher threshold voltage Vthr_Off applied to the non-inverting input of the amplifier circuit 205 with the rising edge of the LAT_OFF signal at t=t12 or with the trailing edge of the LAT_OFF signal at t=t13. The second one-bit memory 452 latches the result of the comparison with a negative or lower threshold voltage Vthr_On applied to the non-inverting input of the amplifier circuit 205 with the rising edge of the LAT_ON signal at t=t14 or with the trailing edge of the LAT_ON signal at t=t15.

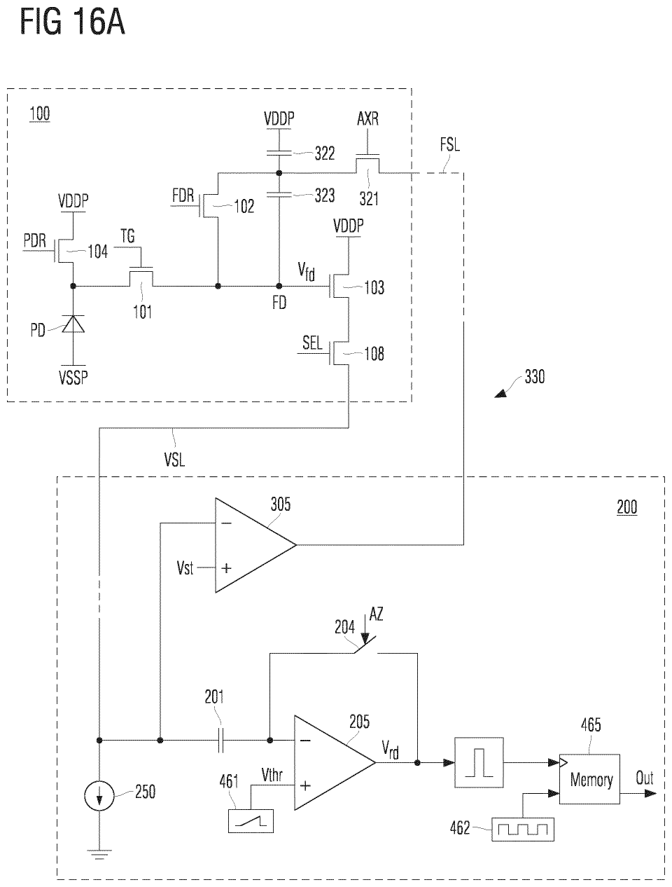

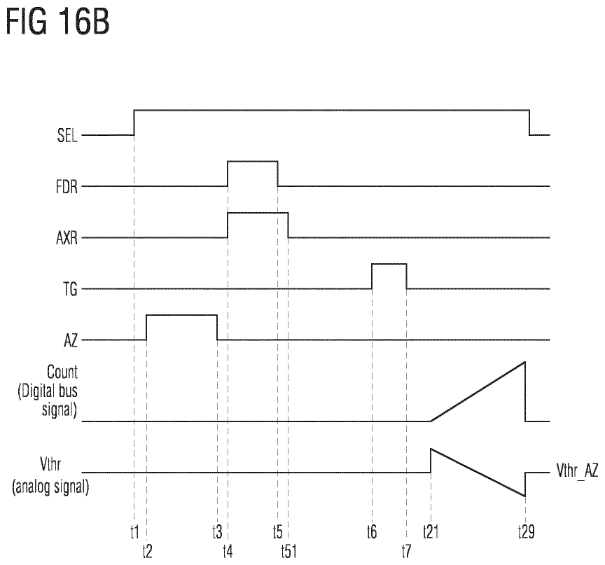

In FIG. 16A, the components of the converter circuit 400 and the amplifier circuit 205 complement each other to an analog-to-digital converter directly converting a voltage difference between the previous pixel signal and the next pixel signal into a multi-bit digital value.

In particular, the solid-state imaging device may include a ramp generator 461 that applies a voltage ramp to the non-inverting input of the amplifier circuit 205.

The amplifier circuit 205, the sample capacitor 201 and the autozero switch element 204 are controlled to subtract the new pixel signal from the previous pixel signal by using the sampled voltage across the sample capacitor 201. The ramp generator 461 generates a voltage ramp and applies the voltage ramp to the non-inverting input of the amplifier circuit 205. The amplifier circuit 205 operates as comparator and changes the voltage level of the binary difference signal Vrd, when the voltage difference between the voltage ramp and the voltage difference between the previous pixel signal and the next pixel signal changes the sign. A pulse generator 462 generates regular clock pulses and passes the clock pulses to a counter circuit 465. The counter circuit 465 starts counting synchronously with the start of the voltage ramp and stops counting, when the voltage level of the binary difference signal Vrd switches.

FIG. 16B shows the synchronous start of counting and voltage ramp at t=t21 and the end of the voltage ramp at t=t29. The tipping point for the binary difference signal Vrd is between t=t21 and t=t29 and depends on the voltage difference between the previous pixel signal and the new pixel signal.

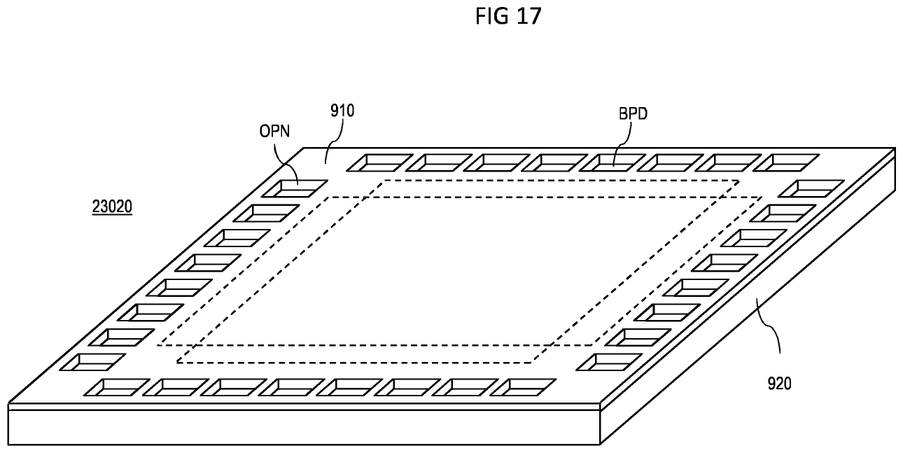

FIG. 17 is a perspective view showing an example of a laminated structure of a solid-state imaging device 23020 with a plurality of pixel circuits arranged matrix-like in array form. Each pixel circuit includes at least one photoelectric conversion element.

The solid-state imaging device 23020 has the laminated structure of a first chip (upper chip) 910 and a second chip (lower chip) 920. The laminated first and second chips 910, 920 may be electrically connected to each other through TC(S)Vs (Through Contact (Silicon) Vias) formed in the first chip 910. The solid-state imaging device 23020 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel circuit, e.g., the photoelectric conversion elements arranged in array form.

For example, the first chip 910 may include only the photoelectric conversion elements of the pixel circuits as described above with reference to the preceding FIGS. Alternatively, the first chip 910 may include further elements of each pixel circuit. For example, the first chip 910 may include, in addition to the photoelectric conversion elements, at least the transfer transistor, the reset transistor, the amplification transistor, and/or the selection transistor of the pixel circuits. Alternatively, the first chip 910 may include each element of the pixel circuit. In addition to the elements of the pixel circuits, the first chip 910 may include one, some or all elements of the signal conversion units, e.g., some or all elements of the differencing circuit, the constant current circuit and/or the converter circuit as described above.

The second chip 920 may be mainly a logic chip (digital chip) that includes the elements complementing the elements on the first chip 910 to complete pixel circuits and/or the signal conversion units. The second chip 920 may also include analog circuits, for example circuits that quantize analog signals transferred from the first chip 910 through the TCVs. For example, the second chip 920 may include all or at least some of the components of the ADC units as described with reference to the preceding Figures.

The second chip 920 may have one or more bonding pads BPD and the first chip 910 may have openings OPN for use in wire-bonding to the second chip 920. The solid-state imaging device 23020 with the laminated structure of the two chips 910, 920 may have the following characteristic configuration:

The electrical connection between the first chip 910 and the second chip 920 is performed through, for example, the TCVs. The TCVs may be arranged at chip ends or between a pad region and a circuit region. The TCVs for transmitting control signals and supplying power may be mainly concentrated at, for example, the four corners of the solid-state imaging device 23020, by which a signal wiring area of the first chip 910 can be reduced.

The technology according to the present disclosure may be realized in a light receiving device mounted in a mobile body of any type such as automobile, electric vehicle, hybrid electric vehicle, motorcycle, bicycle, personal mobility, airplane, drone, ship, or robot.

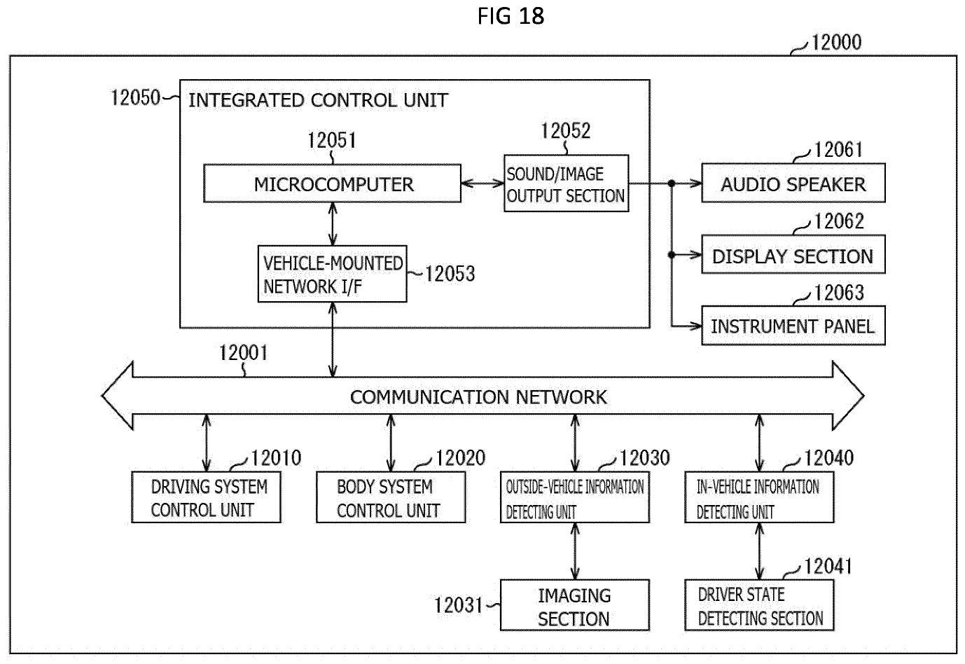

FIG. 18 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 12, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include a solid-state imaging device that includes signal conversion units with differencing circuits according to the embodiments of the present disclosure. The light received by the imaging section 12031 may be visible light, or may be invisible light such as infrared rays or the like.

The in-vehicle information detecting unit 12040 detects information about the inside of the vehicle and may be or may include a solid-state imaging device with a raw driver assembly according to the embodiments of the present disclosure. The in-vehicle information detecting unit 12040 is, for example, connected with a driver state detecting section 12041 that detects the state of a driver. The driver state detecting section 12041, for example, includes a camera that includes the solid-state imaging device and that is focused on the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 18, an audio speaker 12061, a display section 12062, and an instrument panel 12063 are illustrated as the output device. The display section 12062 may, for example, include at least one of an on-board display or a head-up display, wherein each of them may include a solid-state imaging device with a comparing circuit as described with reference to the preceding Figures.

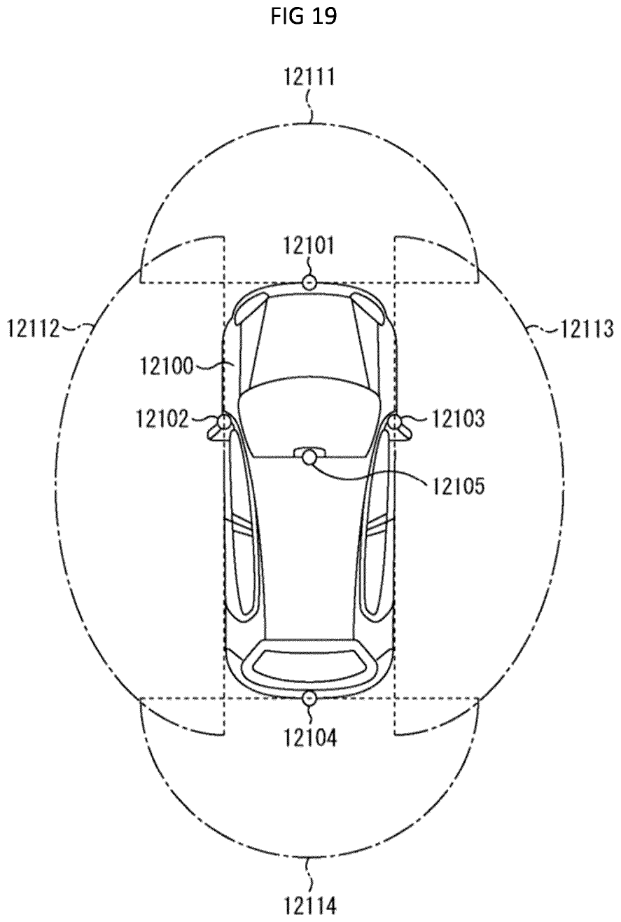

FIG. 19 is a diagram depicting an example of the installation position of the imaging section 12031, wherein the imaging section 12031 may include imaging sections 12101, 12102, 12103, 12109, and 12105.

The imaging sections 12101, 12102, 12103, 12109, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12109 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 19 depicts an example of photographing ranges of the imaging sections 12101 to 12109. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12109 provided to the rear bumper or the back door. A bird's-eye image of the vehicle 12100 as viewed from above is obtained by superimposing image data imaged by the imaging sections 12101 to 12109, for example.

At least one of the imaging sections 12101 to 12109 may have a function of obtaining distance information. For example, at least one of the imaging sections 12101 to 12109 may be a stereo camera constituted of a plurality of imaging elements, imaging element having pixels for phase difference detection or may include a ToF module including a high dynamic range image sensor that includes a signal conversion unit with a differencing circuit according to the present disclosure.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12109, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12109, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12109 may be an infrared camera that detects infrared rays. The microcomputer 12051 can, for example, recognize a pedestrian by determining whether or not there is a pedestrian in imaged images of the imaging sections 12101 to 12109. Such recognition of a pedestrian is, for example. performed by a procedure of extracting characteristic points in the imaged images of the imaging sections 12101 to 12109 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12109, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to an embodiment of the present disclosure is applicable has been described above. By applying an image sensor that includes a signal conversion unit with a differencing circuit according to the present disclosure, power consumption can be further improved and sensor reaction time can be improved.

Additionally, embodiments of the present technology are not limited to the above-described embodiments, but various changes can be made within the scope of the present technology without departing from the gist of the present technology.

A solid-state imaging device including an image sensor assembly that includes signal conversion units with a differencing circuit according to the present disclosure may be any device used for analyzing and/or processing radiation such as visible light, infrared light, ultraviolet light, and X-rays. For example, the solid-state imaging device may be any electronic device in the field of traffic, the field of home appliances, the field of medical and healthcare, the field of security, the field of beauty, the field of sports, the field of agriculture, the field of image reproduction, the field of eye tracking, the field of structured light appliances, or the like.

Specifically in the field of eye tracking, due to the fast motion of the eye and the necessary optical flow accuracy, the image sensor typically operates with high frame rates of 200 Hz and more. An image sensor with a conversion circuit based on differencing circuits as described in the present application can reduce sensing and processing power by reducing number and range of AD conversions and producing sparser but still informative information. Frame differencing in the digital domain may be reduced or completely omitted.

In structured light systems, a laser pulse scans a scene at high velocity. An image sensor observing the scanned scene must be sufficiently fast to reliably detect the reflected laser light. The present embodiments, in particular those described with reference to FIGS. 9A to 16B, allow for significant speed improvements compared to other CIS sensors. Due to the compact size of the pixel circuits that include only four to five transistors, high resolution can be obtained.

In the field of image reproduction, the solid-state imaging device may be a device for capturing an image to be provided for appreciation, such as a digital camera, a smart phone, or a mobile phone device having a camera function. In the field of traffic, for example, the solid-state imaging device may be integrated in an in-vehicle sensor that captures the front, rear, peripheries, an interior of the vehicle, etc, for safe driving such as automatic stop, recognition of a state of a driver, or the like, in a monitoring camera that monitors traveling vehicles and roads, or in a distance measuring sensor that measures a distance between vehicles or the like.

In the field of home appliances, the solid-state imaging device may be integrated in any type of sensor that can be used in devices provided for home appliances such as TV receivers, refrigerators, and air conditioners to capture gestures of users and perform device operations according to the gestures. Accordingly the solid-state imaging device may be integrated in home appliances such as TV receivers, refrigerators, and air conditioners and/or in devices controlling the home appliances. Furthermore, in the field of medical and healthcare, the solid-state imaging device may be integrated in any type of sensor, e.g, a solid-state image device, provided for use in medical and healthcare, such as an endoscope or a device that performs angiography by receiving infrared light.

In the field of security, the solid-state imaging device can be integrated in a device provided for use in security, such as a monitoring camera for crime prevention or a camera for person authentication use. Furthermore, in the field of beauty, the solid-state imaging device can be used in a device provided for use in beauty, such as a skin measuring instrument that captures skin or a microscope that captures a probe. In the field of sports, the solid-state imaging device can be integrated in a device provided for use in sports, such as an action camera or a wearable camera for sport use or the like. Furthermore, in the field of agriculture, the solid-state imaging device can be used in a device provided for use in agriculture, such as a camera for monitoring the condition of fields and crops.

The present technology can also be configured as described below:
(1) A solid-state imaging device, including: pixel circuits, wherein each pixel circuit is configured to output pixel signals on a data signal line in response to an active row select signal in a row selection interval, wherein each pixel circuit includes a floating diffusion, and wherein a floating diffusion potential of the floating diffusion determines a voltage level of the pixel signals; and a differencing circuit configured to receive, for each of the pixel circuits, two pixel signals successively transmitted from the pixel circuit on the data signal line within a same row selection interval, and to obtain a difference signal from the two pixel signals, wherein the solid-state imaging device is configured to control each pixel circuit to output a previous pixel signal and a new pixel signal in a same row selection interval, and wherein the previous pixel signal and the new pixel signal contain image information about an imaged scene at different points in time.
(2) The solid-state imaging device according to (1), wherein the solid-state imaging device is configured to control the floating diffusion to keep a floating diffusion potential from a readout of a new pixel signal in a first row selection interval for a pixel circuit until a readout of a previous pixel signal in a second row selection interval for the pixel circuit.
(3) The solid-state imaging device according to any of (1) to (2), wherein the differencing circuit includes an amplifier circuit, a sample capacitor in a first input leg between the data signal line and an inverting input of the amplifier circuit, and a switchable feedback path between an output of the amplifier circuit and the inverting input of the amplifier circuit.
(4) The solid-state imaging device according to (3), wherein the solid-state imaging device is configured to control the differencing circuit to sample a voltage corresponding to a signal level of a first pixel signal across the sample capacitor in a first phase, and to obtain the difference signal from a difference between the voltage sampled at the sample capacitor and a voltage level of a second pixel signal applied to an input electrode of the sample capacitor in a second phase.
(5) The solid-state imaging device according to (3), wherein the solid-state imaging device is configured to control the differencing circuit to sample a voltage corresponding to a signal level of a previous pixel signal across the sample capacitor in a first phase, and to obtain the difference signal from a difference between the voltage sampled at the sample capacitor and a voltage level of a next pixel signal applied to an input electrode of the sample capacitor in a second phase, wherein the previous pixel signal and the new pixel signal contain image information about an imaged scene at different points in time.
(6) The solid-state imaging device according to any of (1) to (5), further including: a noise reduction circuit configured to reduce kTC noise in the pixel signals prior to obtaining the difference signal.
(7) The solid-state imaging device according to any of (1) to (6), wherein the differencing circuit includes a fully differential amplifier and a sample/hold circuit electrically connected in a first input leg between the data signal line and a first input of the fully differential amplifier, and wherein a second input leg couples the data signal line and a second input of the fully differential amplifier.
(8) The solid-state imaging device according to (7), further including: a first sample capacitor in a portion of the first input leg between the sample/hold circuit and the first input of the differential amplifier circuit, a second sample capacitor in the second input leg between the data signal line and the second input of the differential amplifier circuit, a first gain capacitor in a first feedback path between a second amplifier output and the first amplifier input, and a second gain capacitor in second feedback path between a first amplifier output and the second amplifier input.
(9) The solid-state imaging device according to any of (1) to (8), wherein the pixel circuit further includes a photoelectric conversion element configured to determine the floating diffusion potential by photocurrent, and a transfer transistor configured to connect a cathode of the photoelectric conversion element and the floating diffusion in response to an active transfer signal in the row selection interval.
(10) The solid-state imaging device according to (9), wherein the pixel circuit further includes a photodetector reset transistor configured to reset a potential at the cathode of the photoelectric conversion element to a fixed potential in response to an active photodetector reset signal.
(11) The solid-state imaging device according to any of (1) to (10), wherein the pixel circuit further includes a floating diffusion reset transistor configured to connect the floating diffusion with a pixel reset voltage in response to at least an active floating diffusion reset signal, and wherein the pixel circuit further includes an auxiliary transistor electrically connected in series between the floating diffusion reset transistor and a node supplying the pixel reset voltage and configured to connect the floating diffusion reset transistor to the node supplying the pixel reset voltage in response to an active auxiliary signal, and a pixel coupling capacitor electrically connected in parallel to the floating diffusion reset transistor.
(12) The solid-state imaging device according to any of (1) to (11), wherein the pixel circuit further includes a floating diffusion reset transistor configured to connect the floating diffusion with a pixel reset voltage in response to at least an active floating diffusion reset signal, and further including a threshold drift compensation circuit configured to control the pixel reset voltage as a function of a current voltage of the pixel signal on the data signal line.
(13) The solid-state imaging device according to any of (1) to (12), further including: a converter circuit configured to gate the difference signal with a threshold signal.
(14) The solid-state imaging device according to (13), wherein the converter circuit is configured to obtain digital event information from the difference signal.
(15) The solid-state imaging device according to any of (13) to (14), wherein the converter circuit includes an analog-to-digital converter, and wherein the solid-state imaging device is configured to control the analog-to-digital converter such that the difference signal is quantized with high accuracy only when after k out of N possible quantization steps the difference signal is above a predefined frame difference threshold.
(16) The solid-state imaging device according to any of (1) to (2) and (6) to (12), wherein the differencing circuit includes an amplifier circuit, a sample capacitor in a first input leg between the data signal line and an inverting input of the amplifier circuit, and an autozero switch clement between an output of the amplifier circuit and the inverting input of the amplifier circuit, and wherein the differencing circuit is configured to receive a variable threshold signal at the non-inverting input of the amplifier circuit.
(17) The solid-state imaging device according to (16), further including: a ramp generator configured to apply a voltage ramp to the non-inverting input of the sunplifier circuit.

1. A solid-state imaging device, comprising:
pixel circuits, wherein each pixel circuit is configured to output pixel signals on a data signal line in response to an active row select signal in a row selection interval, wherein each pixel circuit comprises a floating diffusion, and wherein a floating diffusion potential of the floating diffusion determines a voltage level of the pixel signals; and
a differencing circuit configured to receive, for each of the pixel circuits, two pixel signals successively transmitted from the pixel circuit on the data signal line within a same row selection interval, and to obtain a difference signal from the two pixel signals,
wherein the solid-state imaging device is configured to control each pixel circuit to output a previous pixel signal and a new pixel signal in a same row selection interval, and wherein the previous pixel signal and the new pixel signal contain image information about an imaged scene at different points in time.

2. The solid-state imaging device according to claim 1,
wherein the solid-state imaging device is configured to control the floating diffusion to keep a floating diffusion potential from a readout of a new pixel signal in a first row selection interval for a pixel circuit until a readout of a previous pixel signal in a second row selection interval for the pixel circuit.

3. The solid-state imaging device according to claim 1,
wherein the differencing circuit comprises an amplifier circuit, a sample capacitor in a first input leg between the data signal line and an inverting input of the amplifier circuit, and a switchable feedback path between an output of the amplifier circuit and the inverting input of the amplifier circuit.

4. The solid-state imaging device according to claim 3,
wherein the solid-state imaging device is configured to control the differencing circuit to sample a voltage corresponding to a signal level of a first pixel signal across the sample capacitor in a first phase, and to obtain the difference signal from a difference between the voltage sampled at the sample capacitor and a voltage level of a second pixel signal applied to an input electrode of the sample capacitor in a second phase.

5. The solid-state imaging device according to claim 3,
wherein the solid-state imaging device is configured to control the differencing circuit to sample a voltage corresponding to a signal level of a previous pixel signal across the sample capacitor in a first phase, and to obtain the difference signal from a difference between the voltage sampled at the sample capacitor and a voltage level of a next pixel signal applied to an input electrode of the sample capacitor in a second phase, wherein the previous pixel signal and the new pixel signal contain image information about an imaged scene at different points in time.

6. The solid-state imaging device according to claim 1, further comprising:
a noise reduction circuit configured to reduce kTC noise in the pixel signals prior to obtaining the difference signal.

7. The solid-state imaging device according to claim 1,
wherein the differencing circuit comprises a fully differential amplifier and a sample/hold circuit electrically connected in a first input leg between the data signal line and a first input of the fully differential amplifier, and wherein a second input leg couples the data signal line and a second input of the fully differential amplifier.

8. The solid-state imaging device according to claim 7, further comprising:
a first sample capacitor in a portion of the first input leg between the sample/hold circuit and the first input of the differential amplifier circuit, a second sample capacitor in the second input leg between the data signal line and the second input of the differential amplifier circuit, a first gain capacitor in a first feedback path between a second amplifier output and the first amplifier input, and a second gain capacitor in second feedback path between a first amplifier output and the second amplifier input.

9. The solid-state imaging device according to claim 1,
wherein the pixel circuit further comprises a photoelectric conversion element configured to determine the floating diffusion potential by photocurrent, and a transfer transistor configured to connect a cathode of the photoelectric conversion element and the floating diffusion in response to an active transfer signal in the row selection interval.

10. The solid-state imaging device according to claim 9,
wherein the pixel circuit further comprises a photodetector reset transistor configured to reset a potential at the cathode of the photoelectric conversion element to a fixed potential in response to an active photodetector reset signal.

11. The solid-state imaging device according to claim 1,
wherein the pixel circuit further comprises a floating diffusion reset transistor configured to connect the floating diffusion with a pixel reset voltage in response to at least an active floating diffusion reset signal, and
wherein the pixel circuit further comprises an auxiliary transistor electrically connected in series between the floating diffusion reset transistor and a node supplying the pixel reset voltage and configured to connect the floating diffusion reset transistor to the node supplying the pixel reset voltage in response to an active auxiliary signal, and a pixel coupling capacitor electrically connected in parallel to the floating diffusion reset transistor.

12. The solid-state imaging device according to claim 1,
wherein the pixel circuit further comprises a floating diffusion reset transistor configured to connect the floating diffusion with a pixel reset voltage in response to at least an active floating diffusion reset signal, and further comprising
a threshold drift compensation circuit configured to control the pixel reset voltage as a function of a current voltage of the pixel signal on the data signal line.

13. The solid-state imaging device according to claim 1, further comprising:
a converter circuit configured to gate the difference signal with a threshold signal.

14. The solid-state imaging device according to claim 13,
wherein the converter circuit is configured to obtain digital event information from the difference signal.

15. The solid-state imaging device according to claim 13,
wherein the converter circuit comprises an analog-to-digital converter, and wherein the solid-state imaging device is configured to control the analog-to-digital converter such that the difference signal is quantized with high accuracy only when after k out of N possible quantization steps the difference signal is above a predefined frame difference threshold.

16. The solid-state imaging device according to claim 1,
wherein the differencing circuit comprises an amplifier circuit, a sample capacitor in a first input leg between the data signal line and an inverting input of the amplifier circuit, and an autozero switch element between an output of the amplifier circuit and the inverting input of the amplifier circuit, and wherein the differencing circuit is configured to receive a variable threshold signal at the non-inverting input of the amplifier circuit.

17. The solid-state imaging device according to claim 16, further comprising:
a ramp generator configured to apply a voltage ramp to the non-inverting input of the amplifier circuit.
